(19) United States
(12) Patent Application Publication
(10) Pub. No.: US 2008/0238844 A1
(43) Pub. Date: Oct. 2, 2008

(54) LIQUID CRYSTAL DRIVER CIRCUIT AND METHOD OF DRIVING LIQUID CRYSTAL DISPLAY DEVICE INCLUDING THE SAME

(75) Inventors: Takaaki KAKIUCHI, Kanagawa (JP); Kouichi OOGA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD., Kanagawa (JP)

(21) Appl. No.: 12/044,381

(22) Filed: Mar. 7, 2008

(30) Foreign Application Priority Data
Mar. 29, 2007 (JP) 2007-087877

(51) Int. Cl. G09G 3/36

(52) U.S. Cl. 345/87

(57) ABSTRACT

A liquid crystal driver circuit includes a timing controller emitting at least two control signals therefrom, and at least two gate drivers receiving the control signals from the timing controller. The control signals are controlled such that signal levels thereof are not simultaneously varied.

### BACKGROUND OF THE INVENTION

1. Field of the Invention

The invention relates to a liquid crystal driver circuit, a liquid crystal display device including the same, and a method of driving the liquid crystal display device.

2. Description of the Related Art

A recent liquid crystal display device is designed to include a large-sized screen, and have high definition.

An increase in a wire length resulted from a large-sized screen causes an increase a wire-delay time. In addition, high definition causes a driver frequency higher. This causes an increase in a number of gate drivers used in a liquid crystal display device, resulting in an increase a load to be exerted on gate drivers.

In light of the problems mentioned above, Japanese Patent Application Publication No. 11-259050 (published on September 1999) has suggested a delay unit for delaying signal-transmission timing, disposed between bits of display data for red, green and blue.

FIG. 1 is a timing chart of control signals running in a related liquid crystal driver circuit used for driving a liquid crystal display device.

Signals transmitted from a timing controller equipped in a liquid crystal display circuit to gate drivers include, for instance, as illustrated in FIG. 1, a start pulse (VSP) signal, an out-enable (VOE) signal, and a clock (VCK) signal, as gate signals for controlling the gate drivers.

As illustrated in FIG. 1, the out-enable (VOE) signal is in synchronization with the clock (VCK) signal in the related liquid crystal driver circuit.

The liquid crystal driver circuit includes a plurality of gate drivers electrically connected in cascade with one another. A first gate driver, that is, a gate driver disposed most upstream in the gate drivers, outputs a gate signal VOUT1, a second gate driver, that is, a gate driver disposed adjacent to the first gate driver, outputs a gate signal VOUT2, and a third gate driver, that is, a gate driver disposed adjacent to the second gate driver, outputs a gate signal VOUT3. Each of the gate signals VOUT1, VOUT2 and VOUT3 rises up when the out-enable (VOE) signal falls down.

The delay unit suggested in the above-mentioned Publication is accompanied with a problem that a timing at which a gate signal is transmitted is not considered, resulting in heavy load is exerted on the gate drivers.

Furthermore, since the out-enable (VOE) signal and the clock (VCK) signal rise up simultaneously in the timing chart of FIG. 1, logic loads are exerted simultaneously on the gate drivers because the out-enable (VOE) signal and the clock (VCK) signal simultaneously rise up. As a result, there is caused a problem that heavy load is exerted on the gate drivers, resulting in an increase in power-source ripple.

Japanese Patent Application Publication No. 2003-162262 has suggested a liquid crystal panel driver circuit including a plurality of output circuits each electrically connected with each of data bus lines in a liquid crystal panel, and each outputting a liquid crystal driver voltage. The liquid crystal driver voltage is output with a delay which is greater in a data bus line closer to a final data bus line.

Japanese Patent Application Publication No. 2005-10791 has suggested an apparatus for driving a liquid crystal display device, including an image-signal processor which separates both a TV-image signal and a complex synchronization signal out of a complex image signal, a liquid crystal display panel displaying images in accordance with the TV-image signal, a timing controller producing a source start pulse which defines a timing at which the TV-image signal starts to be displayed in the liquid crystal display panel, in accordance with both an internal clock signal and the complex synchronization signal, and a delay circuit for delaying the internal clock signal and outputting the delayed internal clock signal to the timing controller.

Japanese Patent Application Publication No. 2005-70706 has suggested a display driver for driving a display panel including a plurality of scanning lines, a plurality of data lines extending perpendicularly to the scanning lines, and a plurality of pixels disposed in the vicinity of intersections at which the scanning lines intersect with the data lines. The display driver includes first means for selecting a pixel(s) by applying a scanning signal thereto, second means for applying display signal voltage to the selected pixel(s) in accordance with data to be displayed, and third means for controlling an operation of at least the first means and the second means to thereby control an operation of displaying image data in the display panel. The third means includes means for producing a vertical synchronization signal defining a frame period in which the image data is displayed in the display panel, and means for producing a polarity inversion signal for controlling a polarity of a voltage applied to the pixel(s).

Japanese Patent Application Publication No. 2005-141231 has suggested a timing controller to be used in a LCD driver, for controlling both a timing at which a scan-line driving circuit operates and a timing at which a data-line driving circuit operates. The timing controller includes an n-bit counter which is clocked by a vertical synchronization signal to count a number of pulses in the vertical synchronization signal, and outputs an n-bit counting signal as a result of counting the number, a judgment circuit which receives the n-bit counting signal, compares the received n-bit counting signal with a predetermined n-bit reference signal, and outputs the comparison result, a first NAND gate which makes a logic product of a signal transmitted from the judgment circuit and a data-enable signal, a second NAND gate which makes a logic product of a signal transmitted from the first NAND gate with a clock signal, and a memory receiving first display data in response to a signal transmitted from the first NAND gate, and storing the first display data therein.

Japanese Patent Application Publication No. 2005-173418 has suggested an apparatus for driving a light-emitting display panel including a scanning driver and a data driver for driving a light-emitting display panel. The scanning driver puts each of scanning signal lines into a selected condition in synchronization with a data-latch signal which latches a data signal transmitted to the data driver for single scan, and puts each of scanning signal lines into a non-selected condition until a predetermined period of time goes by before a timing a next data-latch signal is output.

Japanese Patent Application Publication No. 2005-227412 has suggested a light-emitting display device including a display panel comprised of a plurality of pixels each including a light-emitting device and disposed at intersections of a plurality of scanning lines and a plurality of data lines. The display panel is electrically connected with a circuit which carries out switching. The switching and an operation of selecting a scanning line in the liquid crystal panel is in synchronization with each other.

### SUMMARY OF THE INVENTION

In view of the above-mentioned problems in the related art, it is an exemplary object of the present invention to provide a liquid crystal driver circuit, a liquid crystal display device including the same, and a method of driving the liquid crystal display device, all of which are capable of reducing logic power-source ripple.

In a first exemplary aspect of the present invention, there is provided a liquid crystal driver circuit including a timing controller emitting at least two control signals therefrom, and at least two gate drivers receiving the control signals from the timing controller, wherein the control signals are controlled such that signal levels thereof are not simultaneously varied.

In a second exemplary aspect of the present invention, there is provided a liquid crystal display device including a liquid crystal driver circuit, and a liquid crystal panel, the liquid crystal driver circuit including a timing controller emitting at least two control signals therefrom, and at least two gate drivers each receiving the control signals from the timing controller, and each outputting a gate control signal, wherein the control signals are controlled such that signal levels thereof are not simultaneously varied, and the liquid crystal display panel receives the gate control signal from the gate drivers for operation thereof.

In a third exemplary aspect of the present invention, there is provided a method of driving a liquid crystal display device including a liquid crystal driver circuit and a liquid crystal panel, the liquid crystal driver circuit including a timing controller emitting at least two control signals therefrom, and at least two gate drivers receiving the control signals and outputting a gate control signal to the liquid crystal display panel, the method including (a) producing at least two control signals in the timing controller, (b) varying a timing at which a signal level of at least one of the control signals varies, relative to a timing at which a signal level of the rest of control signals varies, and (c) transmitting the control signals to the liquid crystal panel from the liquid crystal driver circuit.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a timing chart of control signals running in a related liquid crystal driver circuit used for driving a liquid crystal display device.

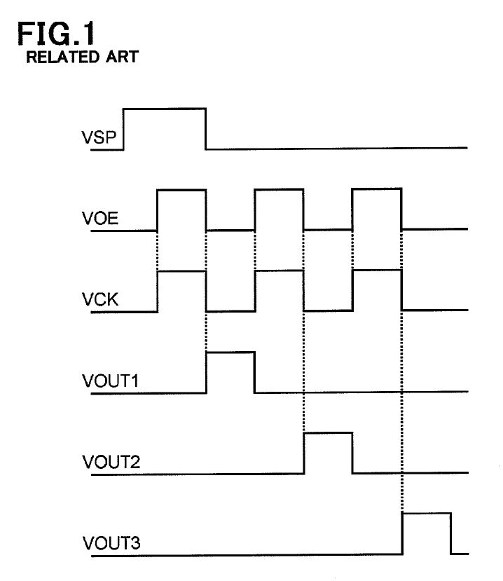

FIG. 2 is a block diagram of a liquid crystal driver circuit in accordance with the first exemplary embodiment of the present invention.

FIG. 3 is a timing chart of control signals running in a liquid crystal driver circuit in accordance with the first exemplary embodiment of the present invention.

FIG. 4 is a block diagram of a liquid crystal display device including a liquid crystal driver circuit in accordance with the first exemplary embodiment of the present invention.

FIG. 5 is a block diagram of a liquid crystal driver circuit in accordance with a first variant of the first exemplary embodiment of the present invention.

FIG. 6 is a block diagram of a liquid crystal driver circuit in accordance with a second variant of the first exemplary embodiment of the present invention.

FIG. 7 is a block diagram of a liquid crystal driver circuit in accordance with a third variant of the first exemplary embodiment of the present invention.

FIG. 8 is a block diagram of a liquid crystal driver circuit in accordance with the second exemplary embodiment of the present invention.

FIG. 9 is a block diagram of a liquid crystal driver circuit in accordance with a first variant of the second exemplary embodiment of the present invention.

FIG. 10 is a block diagram of a liquid crystal driver circuit in accordance with a second variant of the second exemplary embodiment of the present invention.

FIG. 11 is a block diagram of a liquid crystal driver circuit in accordance with a third variant of the second exemplary embodiment of the present invention.

FIG. 12 is a block diagram of a liquid crystal driver circuit in accordance with the third exemplary embodiment of the present invention.

FIG. 13 is a block diagram of a liquid crystal driver circuit in accordance with the fourth exemplary embodiment of the present invention.

FIG. 14 is a block diagram of a liquid crystal driver circuit in accordance with a first variant of the fourth exemplary embodiment of the present invention.

FIG. 15 is a block diagram of a liquid crystal driver circuit in accordance with a second variant of the fourth exemplary embodiment of the present invention.

FIG. 16 is a block diagram of a liquid crystal driver circuit in accordance with a third variant of the fourth exemplary embodiment of the present invention.

### DESCRIPTION OF THE EXEMPLARY EMBODIMENTS

Exemplary embodiments in accordance with the present invention will be explained hereinbelow with reference to drawings.

### First Exemplary Embodiment

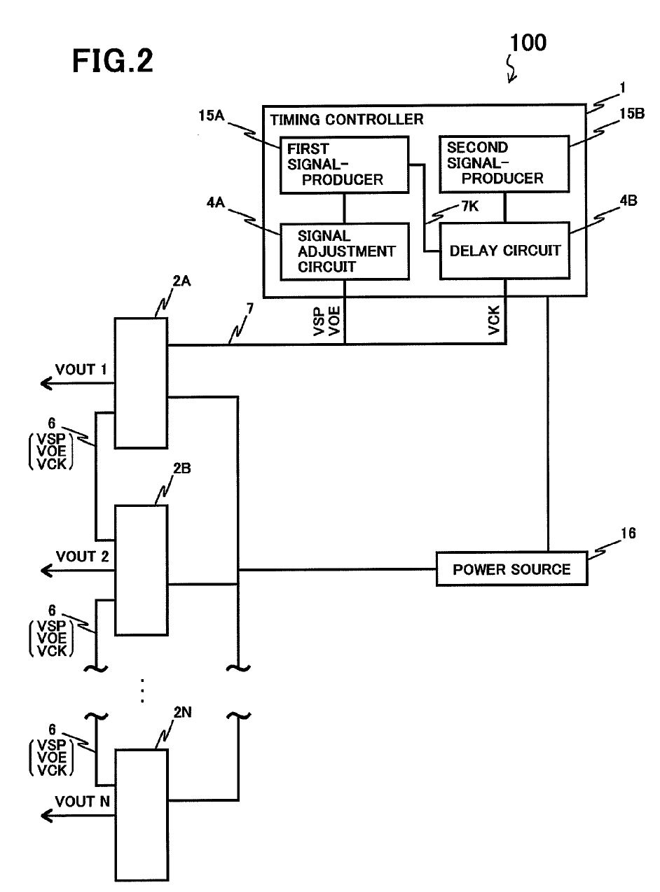

FIG. 2 is a block diagram of a liquid crystal driver circuit 100 in accordance with the first exemplary embodiment of the present invention.

As illustrated in FIG. 2, the liquid crystal driver circuit 100 in accordance with the first exemplary embodiment is comprised of a timing controller 1, and a plurality of gate drivers 2A to 2N.

Each of the gate drivers 2A to 2(N−1) is electrically connected with a gate driver disposed immediately downstream thereof through a signal line 6. That is, the gate drivers 2A to 2N are electrically connected in cascade with one another.

The timing controller 1 includes a first signal-producer 15A, a second signal-producer 15B, a signal adjustment circuit 4A, and a delay circuit 4B.

The first signal-producer 15A is electrically connected with the signal adjustment circuit 4A, and the signal adjustment circuit 4A is electrically connected with a first gate driver 2A through a signal line 7. Herein, the first gate driver 2A indicates a gate driver disposed most upstream among the gate drivers 2A to 2N.

The second signal-producer 15B is electrically connected with the delay circuit 4B, and the delay circuit 4B is electrically connected with the first gate driver 2A through the signal line 7.

The first signal-producer 15A produces a start pulse (VSP) signal and an out-enable (VOE) signal both as gate control signals, and outputs those signals to the signal adjustment circuit 4A.

The second signal-producer 15B produces a clock (VCK) signal as a gate control signal, and outputs the clock (VCK) signal to the delay circuit 4B.

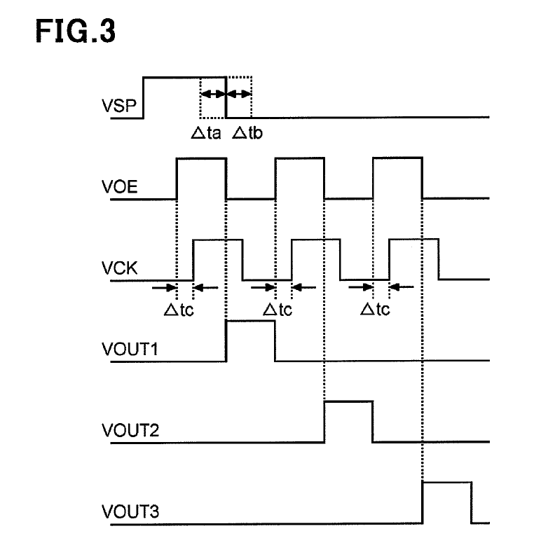

As mentioned later with reference to FIG. 3, the first signal-producer 15A produces the start pulse (VSP) signal and the out-enable (VOE) signal, and the signal adjustment circuit 4A sets a timing at which a signal level of the start pulse (VSP) signal received from the first signal-producer 15A falls down, sooner by Δta or later by Δtb relative to a timing at which a signal level of the out-enable (VOE) signal received from the first signal-producer 15A falls down, thereby ensuring that those timings are not coincident with each other.

As mentioned later with reference to FIG. 3, the second signal-producer 15B produces the clock (VCK) signal, and the delay circuit 4B delays a timing at which a signal level of the clock (VCK) signal received from the second signal-producer 15B rises up, by Δtc relative to a timing at which a signal level of the out-enable (VOE) signal rises up.

The first gate driver 2A transmits the gate control signals (that is, the start pulse (VSP) signal, the out-enable (VOE) signal, and the clock (VCK) signal) having been received from the timing controller 1, to the second gate driver 2B through the signal line 6. Then, the second gate driver 2B transmits the gate control signals having been received from the first gate driver 2A, to the third gate driver 2C through the signal line 6. In the same way, a gate driver 2M (A<M<N) transmits the gate control signals having been received from a gate driver 2(M−1), to a gate driver 2(M+1) through the signal line 6.

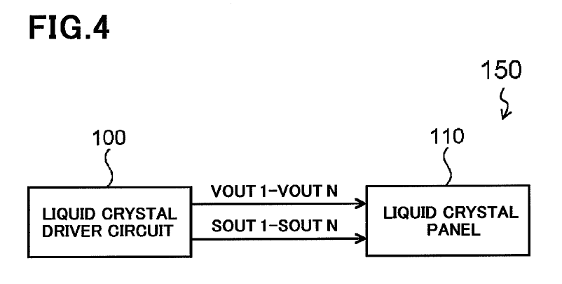

Each of the gate drivers 2A to 2N transmits a gate signal VOUT as a drive signal to a later-mentioned liquid crystal panel 110 (see FIG. 4) at a timing defined by the received gate control signals.

For instance, each of the signal adjustment circuit 4A and the delay circuit 4B is comprised of a delay line.

The timing controller 1 and the gate drivers 2A to 2N commonly receive electrical power from a power source 16 for operation thereof.

FIG. 3 is a timing chart of control signals running in the liquid crystal driver circuit 100 in accordance with the first exemplary embodiment.

As mentioned above, the first signal-producer 15A produces the start pulse (VSP) signal and the out-enable (VOE) signal. The start pulse (VSP) signal and the out-enable (VOE) signal are transmitted to the signal adjustment circuit 4A from the first signal-producer 15A.

The signal adjustment circuit 4A sets a timing at which a signal level of the start pulse (VSP) signal falls down is sooner by Δta than a timing at which the out-enable (VOE) signal falls down, for instance. As an alternative, the signal adjustment circuit 4A sets a timing at which a signal level of the start pulse (VSP) signal falls down is later by Δtb than a timing at which the out-enable (VOE) signal falls down, for instance.

The second signal-producer 15B produces the clock (VCK) signal. The clock (VCK) signal is transmitted to the delay circuit 4B from the second signal-producer 15B.

The first signal producer 15A transmits a signal indicative of a timing at which the out-enable signal (VOE) signal rises up, to the delay circuit 4B through a signal line 7K.

As illustrated in FIG. 3, the delay circuit 4B equipped in the timing controller 1 gives a delay time Δtc to a timing of the clock (VCK) signal, relative to a timing of the out-enable (VOE) signal.

Specifically, as illustrated in FIG. 3, the delay circuit 4B delays a timing at which the clock (VCK) signal rises up, by Δtc relative to a timing at which the out-enable (VOE) signal rises up.

Then, the start pulse (VSP) signal, the out-enable (VOE) signal, and the clock (VCK) signal are transmitted to the first gate driver 2A from the timing controller 1 through the signal line 7.

Then, the first gate driver 2A outputs a gate signal VOUT1 in accordance with the received gate control signals (the start pulse (VSP) signal, the out-enable (VOE) signal, and the clock (VCK) signal).

Then, the first gate driver 2A outputs the gate control signals to the second gate driver 2B through the signal line 6.

On receipt of the gate control signals, the second gate driver 2B outputs a gate signal VOUT1 in accordance with the received gate control signals.

In the same way, on receipt of the gate control signals from a gate driver disposed immediately upstream thereof, a gate driver 2M (A<M<N) outputs a gate signal VOUTM in accordance with the received gate control signals, and then, transmits the gate control signals to a gate driver 2(M+1) disposed immediately downstream thereof.

Each of the gate signals VOUT1 to VOUTN rises up when the out-enable (VOE) signal falls down.

Since the clock (VCK) signal is delayed relative to the out-enable (VOE) signal, the clock (VCK) signal and the out-enable (VOE) signal are input into the gate drivers 2A to 2N at different timings from each other. This ensures that, whereas loads were exerted on the gate drivers at a time in the above-mentioned related liquid crystal driver circuit, loads are partially exerted on the gate drivers 2A to 2N at different timings.

As mentioned above, the timing controller 1 produces the start pulse (VSP) signal and the out-enable (VOE) signal such that a timing at which a signal level of the start pulse (VSP) signal falls down is sooner by Δta than a timing at which the out-enable (VOE) signal falls down, for instance. As an alternative, the timing controller 1 produces the start pulse (VSP) signal and the out-enable (VOE) signal such that a timing at which a signal level of the start pulse (VSP) signal falls down is later by Δtb than a timing at which the out-enable (VOE) signal falls down, for instance.

Thus, a timing at which a signal level of the start pulse (VSP) signal falls down is not coincident with a timing at which the out-enable (VOE) signal falls down.

When a timing at which a signal level of the start pulse (VSP) signal falls down is set later by Δtb than a timing at which the out-enable (VOE) signal falls down, it is preferable that Δtb is not coincident with Δtc. For instance, it is preferable that Δtb is greater than Δtc (Δtb>Δtc). This ensures that a timing at which a signal level of the start pulse (VSP) signal falls down, a timing at which the out-enable (VOE) signal falls down, and a timing at which a signal level of the clock (VCK) signals falls down are not coincident with one another.

FIG. 4 is a block diagram of a liquid crystal display device 150 including the liquid crystal driver circuit 100 in accordance with the first exemplary embodiment.

As illustrated in FIG. 4, the liquid crystal display device 150 is comprised of the liquid crystal driver circuit 100, and a liquid crystal panel 110.

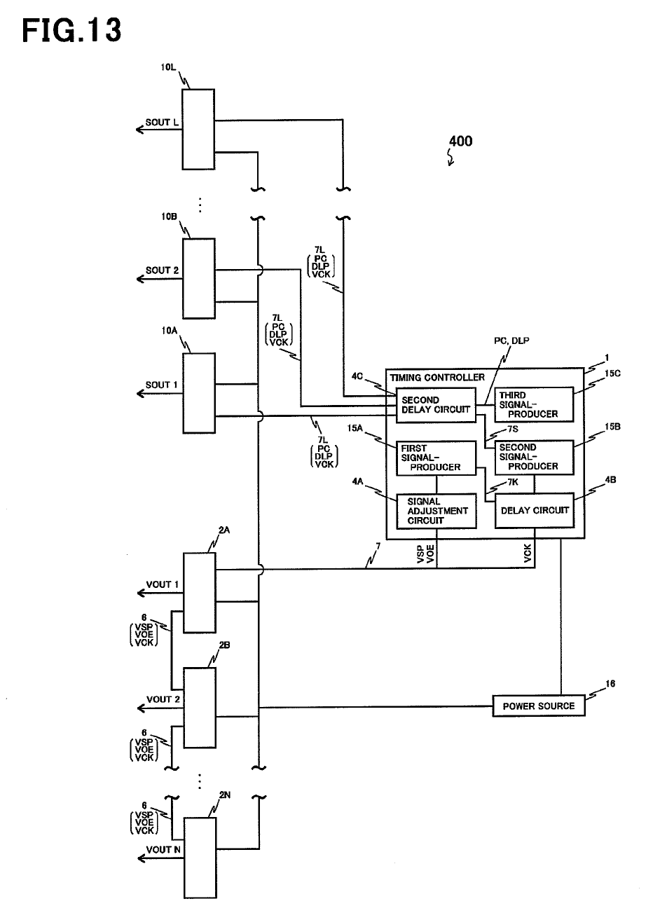

The liquid crystal panel 110 displays images in accordance with both the gate signals VOUT1 to VOUTN received from the gate drivers 2A to 2N, and source signals SOUT1 to SOUTN received from source drivers 10A to 10N (see FIG. 13).

The liquid crystal panel 110 has the same structure as that of a conventional liquid crystal panel except receipt of the gate signals VOUT1 to VOUTN and the source signals SOUT1 to SOUTN from the liquid crystal driver circuit 100, as mentioned above.

In the liquid crystal driver circuit 100 in accordance with the first exemplary embodiment, a timing at which the clock (VCK) signal rises up is delayed by Δtc by the delay circuit 4B relative to a timing at which the out-enable (VOE) signal rises up, and further, the timing controller 1 produces the start pulse (VSP) signal and the out-enable (VOE) signal such that a timing at which a signal level of the start pulse (VSP) signal falls down is sooner by Δta or later by Δtb than a timing at which the out-enable (VOE) signal falls down, for instance. Thus, signal levels of the start pulse (VSP) signal, the out-enable (VOE) signal, and the clock (VCK) signal are not simultaneously varied. This brings advantages as follows.

The first advantage is that it is possible to reduce logic power-source ripple.

This is because deviation of timings of the control signals from one another causes timings of logic input signals to deviate from one another, resulting in that transient currents caused by latch driving are dispersed.

The second advantage is that electrical power consumption can be reduced.

The reduction in power-source ripple mentioned above as the first advantage makes it possible for a power source to have a reduced capacity. As a result, since it is possible to use parts used for a power source, as low-current parts, a loss in electrical power in a power-source circuit is reduced, resulting in reduction in electrical power consumption.

The third advantage is that it is possible to select an optimal control signal timing in order to follow standards defining timings at which control signals are input into gate drivers.

This is because it is possible to adjust timings at which control signals are input into gate drivers regardless of influence exerted by wire delay, by deviating the timings from one another.

The fourth advantage is that countermeasures to EMI can be established.

This is because logic power-source ripple is reduced.

In the first exemplary embodiment, the delay circuit 4 is comprised of a delay line. A structure of the delay circuit 4 is not to be limited to a delay line.

For instance, a number of buffer circuits equipped in a control-signal emitter which is equipped in the timing controller 1, and outputs control signals to the signal line 7 therefrom may be increased only in a signal-transmission path through which a particular control signal (for instance, the clock (VCK) signal) is transmitted, in which case, the particular control signal is delayed relative to the other control signals. In this case, the delay circuit 4 is comprised of the additional buffer circuits. For instance, assuming that a normal number of buffer circuits is six, and a number of buffer circuits to be added is three, the delay circuit 4 is comprised of the additional three buffer circuits.

As an alternative, a number of the above-mentioned buffer circuits may be reduced only in a signal-transmission path through which a particular control signal (for instance, the clock (VCK) signal) is transmitted, in which case, the particular control signal is transmitted earlier than the other control signals.

As an alternative, a number of the above-mentioned buffer circuits may be increased in signal-transmission paths through which the control signals other than a particular control signal (for instance, the clock (VCK) signal) are transmitted, in which case, the particular control signal is transmitted earlier than the other control signals.

In the above-mentioned first exemplary embodiment, the timing controller 1 varies a timing at which a signal level of the start pulse (VSP) signal falls down, relative to a timing at which the out-enable (VOE) signal falls down. As an alternative, the timing controller 1 may vary a timing at which the out-enable (VOE) signal falls down, relative to a timing at which a signal level of the start pulse (VSP) signal falls down. In brief, the timing controller 1 may vary a timing at which one of the control signals falls down, relative to a timing at which the rest of the control signals falls down.

In the above-mentioned first exemplary embodiment, the delay circuit 4B delays a timing at which the clock (VCK) signal rises up, by Δtc relative to a timing at which the out-enable (VOE) signal rises up. In contrast, the delay circuit 4B may be designed to delay the out-enable (VOE) signal relative to the clock (VCK) signal.

As an alternative, the delay circuit 4B may be designed to delay any two or more control signals relative to the rest of the control signals.

### First Variant of First Exemplary Embodiment

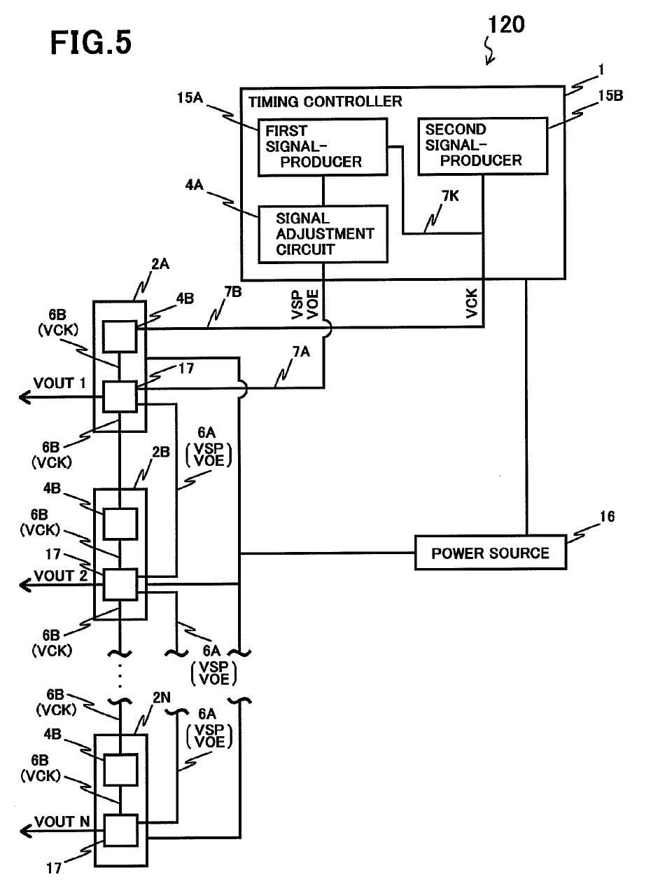

FIG. 5 is a block diagram of a liquid crystal driver circuit 120 in accordance with a first variant of the first exemplary embodiment of the present invention.

Whereas the delay circuit 4B is equipped in the timing controller 1 in the first exemplary embodiment, each of the gate drivers 2A to 2N is designed to include the delay circuit 4B therein in the first variant, as illustrated in FIG. 5.

The first variant is structurally different from the first exemplary embodiment in that the delay circuit 4B is equipped in each of the gate drivers 2A to 2N in place of in the timing controller 1, and the first variant is structurally identical with the first exemplary embodiment except that. Thus, parts or elements that correspond to those of the first exemplary embodiment have been provided with the same reference numerals, and operate in the same manner as corresponding parts or elements in the first embodiment, unless explicitly explained hereinbelow.

The delay circuit 4B equipped in the first gate driver 2A delays the clock (VCK) signal received from the timing controller 1, before the first gate driver 2A produces and outputs a gate signal VOUT1 in accordance with the clock (VCK) signal received from the timing controller 1. The delay circuit 4B equipped in the second gate driver 2B delays the clock (VCK) signal received from the first gate driver 2A, before the second gate driver 2B produces and outputs a gate signal VOUT2 in accordance with the clock (VCK) signal received from the first gate driver 2A. Thus, the delay circuit 4B equipped in the gate driver 2M (A≦M≦N) delays the clock (VCK) signal received from the timing controller 1 or the gate driver 2(M−1), before the gate driver 2M produces and outputs a gate signal VOUTM in accordance with the clock (VCK) signal received from the gate driver 2(M−1).

Each of the gate drivers 2A to 2N is designed to include a gate signal producer 17 which produces a gate signal VOUT and outputs the same to the liquid crystal panel 110 (see FIG. 4).

In each of the gate drivers 2A to 2N, the delay circuit 4B is disposed upstream of the gate signal producer 17 in a signal-transmission path through which the clock (VCK) signal is transmitted. Specifically, each of the gate drivers 2A to 2N receives the clock (VCK) signal from the timing controller 1 or the gate driver disposed immediately upstream thereof, transmits a gate signal VOUT in accordance with the received clock (VCK) signal, and transmits the clock (VCK) signal to the gate driver disposed immediately downstream thereof.

As illustrated in FIG. 5, the first signal-producer 15A produces the start pulse (VSP) signal and the out-enable (VOE) signal. The start pulse (VSP) signal and the out-enable (VOE) signal are transmitted to the signal adjustment circuit 4A from the first signal-producer 15A.

The signal adjustment circuit 4A sets a timing at which a signal level of the start pulse (VSP) signal falls down is sooner by Δta than a timing at which the out-enable (VOE) signal falls down, for instance. As an alternative, the signal adjustment circuit 4A sets a timing at which a signal level of the start pulse (VSP) signal falls down is later by Δtb than a timing at which the out-enable (VOE) signal falls down, for instance.

Then, the start pulse (VSP) signal and the out-enable (VOE) signal are transmitted to the gate signal producer 17 equipped in the first gate driver 2A from the signal adjustment circuit 4A through a signal line 7A.

After outputting the gate signal VOUT1, the gate signal producer 17 transmits the start pulse (VSP) signal and the out-enable (VOE) signal to the gate signal producer 17 equipped in the second gate driver 2B, through a signal line 6A.

In the same way, each of the gate signal producers 17 equipped in the gate drivers 2B to 2(N−1) receives the start pulse (VSP) signal and the out-enable (VOE) signal from a gate driver disposed immediately upstream thereof, and outputs these signals to a gate driver disposed immediately downstream thereof, after outputting a gate signal VOUT.

Thus, the start pulse (VSP) signal and the out-enable (VOE) signal never pass through the delay circuit 4B equipped in each of the gate drivers 2A to 2N.

The second signal-producer 15B produces the clock (VCK) signal, and transmits the clock (VCK) signal to the delay circuit 4B equipped in the first gate driver 2A, through a signal line 7B.

The delay circuit 4B equipped in the first gate driver 2A delays a timing at which the clock (VCK) signal rises up, by Δtc relative to a timing at which the out-enable (VOE) signal rises up, as illustrated in FIG. 3.

Then, the delay circuit 4B transmits the delayed clock (VCK) signal to the gate signal producer 17 equipped in the first gate driver 2A, through a signal line 6B.

The gate signal producer 17 equipped in the first gate driver 2A transmits the gate signal VOUT1 in accordance with the received clock (VCK) signal.

Then, gate signal producer 17 equipped in the first gate driver 2A transmits the clock (VCK) signal to the delay circuit 4B equipped in the second gate driver 2B, through the signal line 6B.

The delay circuit 4B equipped in the second gate driver 2B delays the received clock (VCK) signal, similarly to the delay circuit 4B equipped in the first gate driver 2A, and the gate driver 2B outputs the gate signal VOUT2, similarly to the gate signal producer 17 equipped in the first gate driver 2A. Then, gate signal producer 17 equipped in the second gate driver 2B transmits the clock (VCK) signal to the delay circuit 4B equipped in the third gate driver 2C, through the signal line 6B.

The steps of receiving the clock (VCK) signal from a gate driver disposed immediately upstream thereof, outputting the gate signal VOUT in accordance with the received clock (VCK) signal, and transmitting the clock (VCK) signal to a gate driver disposed immediately downstream thereof are carried out in each of the gate drivers 2A to 2N.

Whereas the start pulse (VSP) signal and the out-enable (VOE) signal pass only through the gate signal producers 17 equipped in the gate drivers 2A to 2N, the clock (VCK) signal passes through both of the delay circuits 4B and the gate signal producers 17 both equipped in the gate drivers 2A to 2N.

The first variant of the first exemplary embodiment provides the same advantages as those provided by the above-mentioned first exemplary embodiment.

Furthermore, in accordance with the first variant of the first exemplary embodiment, the delay time Δtc is made greater in a gate driver disposed more downstream among the gate drivers 2A to 2N electrically connected in cascade with one another.

Specifically, the clock (VCK) signal running through the first gate driver 2A has the delay time Δtc, the clock (VCK) signal running through the second gate driver 2B has the delay time 2Δtc, and the clock (VCK) signal running through the third gate driver 2C has the delay time 3Δtc, for instance.

The liquid crystal driver circuit 120 in accordance with the first variant of the first exemplary embodiment is designed to include the signal lines 6A and 7A through which the start pulse (VSP) signal and the out-enable (VOE) signal are transmitted, and the signal lines 6B and 7B through which the clock (VCK) signal is transmitted. As an alternative, the liquid crystal driver circuit 120 may be designed to include a single signal line in place of the signal lines 6A, 7A, 6B and 7B such that the signal line electrically connects the timing controller 1 and the first gate driver 2A with each other, and further electrically connects the gate drivers disposed adjacent to each other, in which case, the start pulse (VSP) signal, the out-enable (VOE) signal and the clock (VCK) signal are transmitted through the single signal line, but only the clock (VCK) signal is delayed by the delay circuits 4B, and the start pulse (VSP) signal and the out-enable (VOE) signal are not delayed by the delay circuits 4B.

The above-mentioned matter is applied to the later-mentioned exemplary embodiments and variants thereof which include a plurality of signal lines for transmitting the start pulse (VSP) signal, the out-enable (VOE) signal and the clock (VCK) signal.

### Second Variant of First Exemplary Embodiment

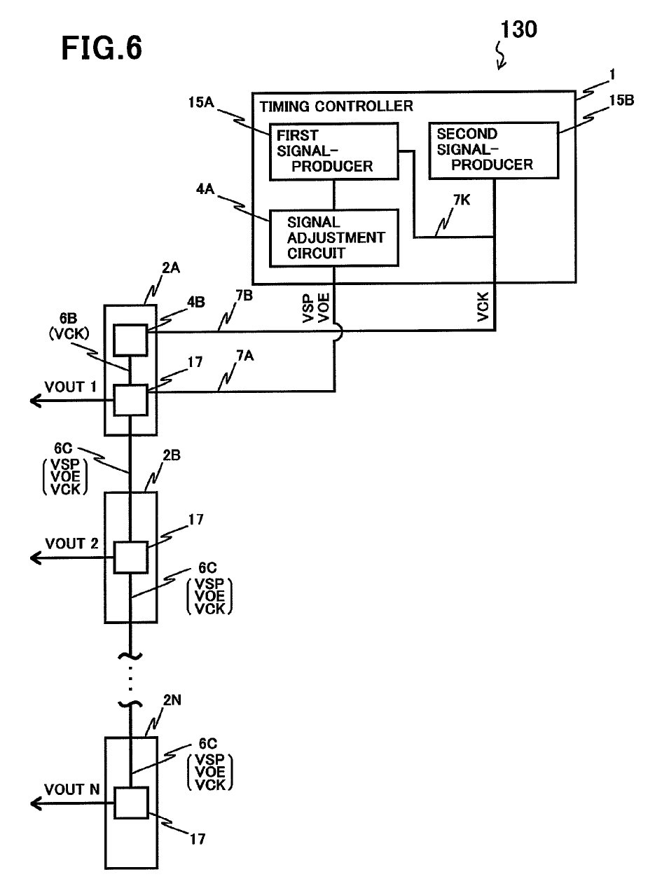

FIG. 6 is a block diagram of a liquid crystal driver circuit 130 in accordance with a second variant of the first exemplary embodiment of the present invention.

Whereas the delay circuit 4B is equipped in all of the gate drivers 2A to 2N in the first variant, the delay circuit 4B is equipped only in the first gate driver 2A in the second variant, as illustrated in FIG. 6.

The second variant is structurally different from the first variant in that the delay circuit 4B is equipped only in the first gate driver 2A, and the second variant is structurally identical with the first variant except that. Thus, parts or elements that correspond to those of the first variant have been provided with the same reference numerals, and operate in the same manner as corresponding parts or elements in the first embodiment, unless explicitly explained hereinbelow.

The delay circuit 4B equipped in the first gate driver 2A delays the clock (VCK) signal received from the timing controller 1, before the gate signal producer 17 equipped in the first gate driver 2A produces and outputs a gate signal VOUT1 in accordance with the clock (VCK) signal received from the timing controller 1.

Each of the gate drivers 2A to 2N receives the clock (VCK) signal from the timing controller 1 or the gate driver disposed immediately upstream thereof, transmits a gate signal VOUT in accordance with the received clock (VCK) signal, and transmits the clock (VCK) signal to the gate driver disposed immediately downstream thereof.

As illustrated in FIG. 6, the first signal-producer 15A produces the start pulse (VSP) signal and the out-enable (VOE) signal. The start pulse (VSP) signal and the out-enable (VOE) signal are transmitted to the signal adjustment circuit 4A from the first signal-producer 15A.

The signal adjustment circuit 4A sets a timing at which a signal level of the start pulse (VSP) signal falls down is sooner by Δta than a timing at which the out-enable (VOE) signal falls down, for instance. As an alternative, the signal adjustment circuit 4A sets a timing at which a signal level of the start pulse (VSP) signal falls down is later by Δtb than a timing at which the out-enable (VOE) signal falls down, for instance.

Then, the start pulse (VSP) signal and the out-enable (VOE) signal are transmitted to the gate signal producer 17 equipped in the first gate driver 2A from the signal adjustment circuit 4A through a signal line 7A.

The second signal-producer 15B produces the clock (VCK) signal, and transmits the clock (VCK) signal to the delay circuit 4B equipped in the first gate driver 2A, through a signal line 7B.

The delay circuit 4B equipped in the first gate driver 2A delays a timing at which the clock (VCK) signal rises up, by Δtc relative to a timing at which the out-enable (VOE) signal rises up, as illustrated in FIG. 3.

Then, the delay circuit 4B transmits the delayed clock (VCK) signal to the gate signal producer 17 equipped in the first gate driver 2A, through a signal line 6B.

The gate signal producer 17 equipped in the first gate driver 2A transmits the gate signal VOUT1 in accordance with the received clock (VCK) signal.

After outputting the gate signal VOUT1, the gate signal producer 17 equipped in the first gate driver 2A transmits the start pulse (VSP) signal, the out-enable (VOE) signal, and the clock (VCK) signal to the gate signal producer 17 equipped in the second gate driver 2B, through a signal line 6C.

Then, gate signal producer 17 equipped in the second gate driver 2B transmits the gate signal VOUT2 in accordance with the received gate control signals.

After outputting the gate signal VOUT2, the gate signal producer 17 equipped in the second gate driver 2B transmits the start pulse (VSP) signal, the out-enable (VOE) signal, and the clock (VCK) signal to the gate signal producer 17 equipped in the third gate driver 2C, through the signal line 6C.

In the same way, each of the gate signal producers 17 equipped in the gate drivers 2B to 2(N−1) receives the start pulse (VSP) signal, the out-enable (VOE) signal, and the clock (VCK) signal from a gate driver disposed immediately upstream thereof, outputs a gate signal VOUT in accordance with the received gate control signals, and outputs the gate control signals to the gate signal producer 17 equipped in a gate driver disposed immediately downstream thereof, after outputting a gate signal VOUT.

Thus, the start pulse (VSP) signal and the out-enable (VOE) signal never pass through the delay circuit 4B, and the clock (VCK) signal passes through the delay circuit 4B only once.

As mentioned above, the delay circuit 4B equipped in the first gate driver 2A delays a timing at which the clock (VCK) signal rises up, by Δtc relative to a timing at which the out-enable (VOE) signal rises up.

The delayed clock (VCK) signal is transmitted to the second or subsequent gate drivers 2B to 2N.

Thus, the second variant of the first exemplary embodiment provides the same advantages as those provided by the above-mentioned first exemplary embodiment.

In the second variant, the delay time Δtc is common in each of the gate drivers 2A to 2N.

### Third Variant of First Exemplary Embodiment

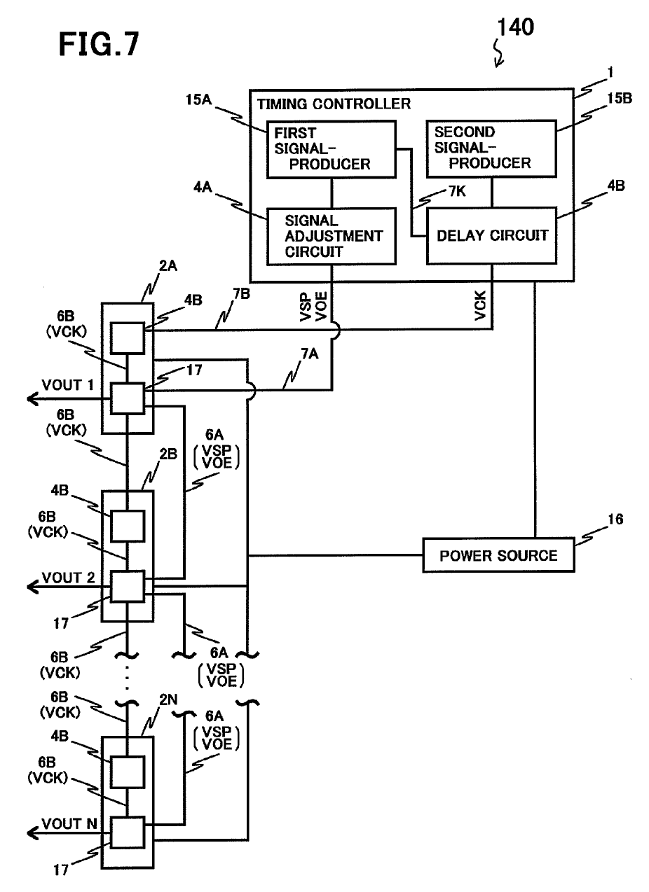

FIG. 7 is a block diagram of a liquid crystal driver circuit 140 in accordance with a third variant of the first exemplary embodiment of the present invention.

In the first exemplary embodiment illustrated in FIG. 2, the delay circuit 4B is equipped in the timing controller 1, and in the first variant illustrated in FIG. 5, the delay circuit 4B is equipped in each of the gate drivers 2A to 2N. In the third variant, the delay circuit 4B is equipped in both the timing controller 1 and the gate drivers 2A to 2N, as illustrated in FIG. 7.

The third variant is structurally different from the first variant (FIG. 5) in that the delay circuit 4B is equipped additionally in the timing controller 1, and the third variant is structurally identical with the first variant except that. Thus, parts or elements that correspond to those of the first variant have been provided with the same reference numerals, and operate in the same manner as corresponding parts or elements in the first embodiment, unless explicitly explained hereinbelow.

The third variant of the first exemplary embodiment provides the same advantages as those provided by the above-mentioned first exemplary embodiment.

In accordance with the third variant, the delay time Δtc is made greater in a gate driver disposed more downstream among the gate drivers 2A to 2N.

Specifically, the clock (VCK) signal running through the first gate driver 2A has the delay time 2Δtc, the clock (VCK) signal running through the second gate driver 2B has the delay time 3Δtc, and the clock (VCK) signal running through the third gate driver 2C has the delay time 4Δtc, for instance.

### Second Exemplary Embodiment

The delay circuit 4B is equipped in the timing controller 1 or in the gate driver(s) in the above-mentioned first exemplary embodiment and the variants thereof. In contrast, the delay circuit 4B is arranged outside the timing controller 1 and the gate drivers 2A to 2N in the second exemplary embodiment.

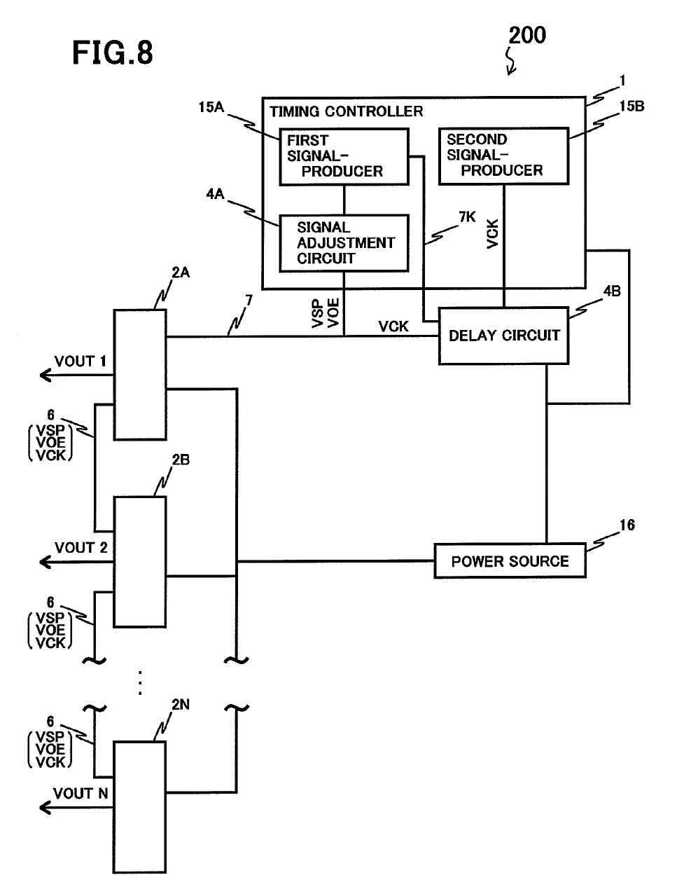

FIG. 8 is a block diagram of a liquid crystal driver circuit 200 in accordance with the second exemplary embodiment of the present invention.

As illustrated in FIG. 8, the liquid crystal driver circuit 200 in accordance with the second exemplary embodiment is comprised of a timing controller 1, a delay circuit 4B, and a plurality of gate drivers 2A to 2N.

Each of the gate drivers 2A to 2(N−1) is electrically connected with a gate driver disposed immediately downstream thereof through a signal line 6. That is, the gate drivers 2A to 2N are electrically connected in cascade with one another.

The timing controller 1 includes a first signal-producer 15A, a second signal-producer 15B, and a signal adjustment circuit 4A.

The first signal-producer 15A is electrically connected with the signal adjustment circuit 4A, and the signal adjustment circuit 4A is electrically connected with a first gate driver 2A through a signal line 7.

The second signal-producer 15B is electrically connected with the delay circuit 4B, and the delay circuit 4B is electrically connected with the first gate driver 2A through the signal line 7.

The first signal-producer 15A produces a start pulse (VSP) signal and an out-enable (VOE) signal both as gate control signals, and outputs those signals to the signal adjustment circuit 4A.

The second signal-producer 15B produces a clock (VCK) signal as a gate control signal, and outputs the clock (VCK) signal to the delay circuit 4B.

The first signal-producer 15A produces the start pulse (VSP) signal and the out-enable (VOE) signal, and the signal adjustment circuit 4A sets a timing at which a signal level of the start pulse (VSP) signal received from the first signal-producer 15A falls down, sooner by Δta or later by Δtb relative to a timing at which a signal level of the out-enable (VOE) signal received from the first signal-producer 15A falls down, thereby ensuring that those timings are not coincident with each other.

The second signal-producer 15B produces the clock (VCK) signal, and the delay circuit 4B delays a timing at which a signal level of the clock (VCK) signal received from the second signal-producer 15B rises up, by Δtc relative to a timing at which a signal level of the out-enable (VOE) signal rises up.

The first gate driver 2A transmits the gate control signals (that is, the start pulse (VSP) signal, the out-enable (VOE) signal, and the clock (VCK) signal) having been received from the timing controller 1, to the second gate driver 2B through the signal line 6. Then, the second gate driver 2B transmits the gate control signals having been received from the first gate driver 2A, to the third gate driver 2C through the signal line 6. In the same way, a gate driver 2M (A<M<N) transmits the gate control signals having been received from a gate driver 2(M−1), to a gate driver 2(M+1) through the signal line 6.

Each of the gate drivers 2A to 2N transmits a gate signal VOUT1 to VOUTN as a drive signal to the liquid crystal panel 110 (see FIG. 4) at a timing defined by the received gate control signals.

For instance, each of the signal adjustment circuit 4A and the delay circuit 4B is comprised of a delay line.

The timing controller 1, the delay circuit 4B, and the gate drivers 2A to 2N commonly receive electrical power from a power source 16 for operation thereof.

The liquid crystal driver circuit 200 in accordance with the second exemplary embodiment operates in the same as the operation of the liquid crystal driver circuit 100 in accordance with the first exemplary embodiment.

Similarly to the liquid crystal display device 150 illustrated in FIG. 4, a liquid crystal display device may be comprised of the liquid crystal driver circuit 200, and a liquid crystal panel 110.

The liquid crystal panel 110 displays images in accordance with both the gate signals VOUT1 to VOUTN received from the gate drivers 2A to 2N, and source signals SOUT1 to SOUTN received from source drivers 10A to 10N (see FIG. 13).

The second exemplary embodiment provides the same advantages as those provided by the above-mentioned first exemplary embodiment.

### First Variant of Second Exemplary Embodiment

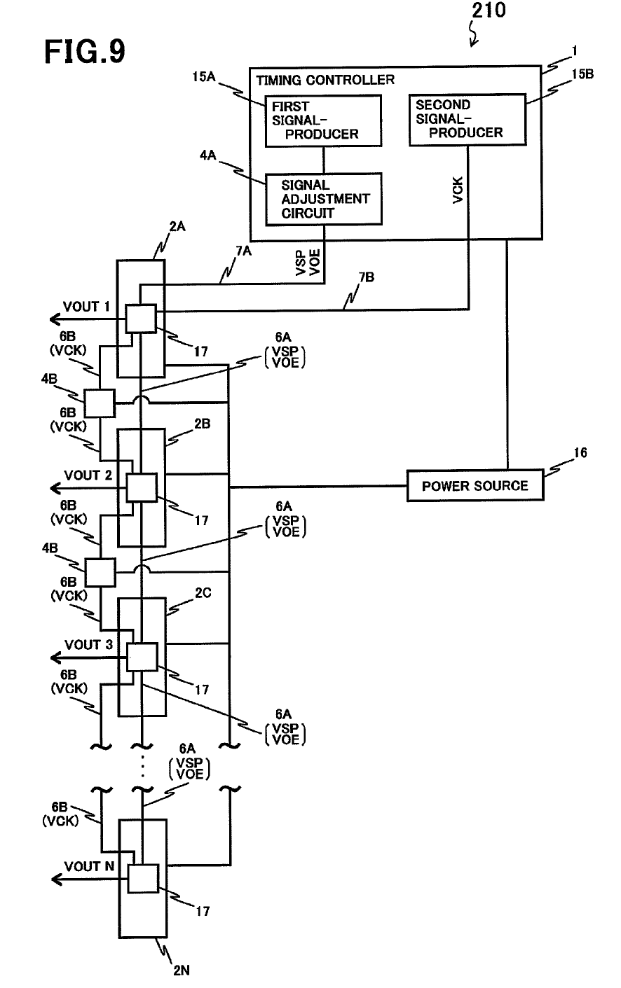

FIG. 9 is a block diagram of a liquid crystal driver circuit 210 in accordance with a first variant of the second exemplary embodiment of the present invention.

Whereas the delay circuit 4B is arranged in the signal line 7 outside the timing controller 1 in the second exemplary embodiment, the delay circuit 4B is arranged in each of signal lines 6B electrically connecting the gate drivers disposed adjacent to each other in the first variant of the second exemplary embodiment, as illustrated in FIG. 9.

The first variant of the second exemplary embodiment is structurally different from the second exemplary embodiment in the followings.

Firstly, as mentioned above, the delay circuit 4B is arranged in each of signal lines 6B electrically connecting the gate drivers disposed adjacent to each other.

Secondly, the gate drivers 2A to 2N are designed to include a gate signal producer 17 which outputs a gate signal VOUT to the liquid crystal panel 110 (see FIG. 4), and the gate signal producers 17 equipped in the gate drivers disposed adjacent to each other are electrically connected to each other through a signal line 6A.

As mentioned below, the clock (VCK) signal passes through the signal lines 6B, whereas the start pulse (VSP) signal and the out-enable (VOE) signal pass through the signal lines 6A.

Thus, parts or elements that correspond to those of the second exemplary embodiment have been provided with the same reference numerals, and operate in the same manner as corresponding parts or elements in the first embodiment, unless explicitly explained hereinbelow.

The operation of the liquid crystal driver circuit 210 is explained hereinbelow.

The first signal-producer 15A produces the start pulse (VSP) signal and the out-enable (VOE) signal. The start pulse (VSP) signal and the out-enable (VOE) signal are transmitted to the signal adjustment circuit 4A from the first signal-producer 15A.

The signal adjustment circuit 4A sets a timing at which a signal level of the start pulse (VSP) signal falls down is sooner by Δta than a timing at which the out-enable (VOE) signal falls down, for instance. As an alternative, the signal adjustment circuit 4A sets a timing at which a signal level of the start pulse (VSP) signal falls down is later by Δtb than a timing at which the out-enable (VOE) signal falls down, for instance.

Then, the start pulse (VSP) signal and the out-enable (VOE) signal are transmitted to the gate signal producer 17 equipped in the first gate driver 2A, through a signal line 7A.

The second signal-producer 15B produces the clock (VCK) signal.

The clock (VCK) signal is transmitted to the gate signal producer 17 equipped in the first gate driver 2A through a signal line 7B.

On receipt of the start pulse (VSP) signal, the out-enable (VOE) signal, and the clock (VCK) signal, the first gate driver 2A transmits a gate signal VOUT1 to the liquid crystal panel 110 (see FIG. 4) in accordance with the received gate control signals.

When the start pulse (VSP) signal, the out-enable (VOE) signal, and the clock (VCK) signal are received in the first gate driver 2A, a timing at which a signal level of the out-enable (VOE) signal rises up is coincident with a timing at which a signal level of the clock (VCK) signal rises up.

After the gate signal VOUT1 has been output to the liquid crystal panel 110, the gate signal producer 17 equipped in the first gate driver 2A outputs the clock (VCK) signal to the delay circuit 4B disposed in the signal line 6B connecting the first gate driver 2A and the second gate driver 2B with each other, and further outputs the start pulse (VSP) signal and the out-enable (VOE) signal to the gate signal producer 17 equipped in the second gate driver 2B through the signal line 6A.

The gate signal producer 17 equipped in the first gate driver 2A further transmits a timing signal indicative of a timing at which the out-enable signal (VOE) signal rises up, to the delay circuit 4B through the signal line 6B.

On receipt of the clock (VCK) signal and the timing signal from the gate signal producer 17 equipped in the first gate driver 2A, the delay circuit 4B equipped gives a delay time Δtc to a timing of the clock (VCK) signal, relative to a timing of the out-enable (VOE) signal.

Specifically, as illustrated in FIG. 3, the delay circuit 4B delays a timing at which the clock (VCK) signal rises up, by Δtc relative to a timing at which the out-enable (VOE) signal rises up.

Then, the thus delayed clock (VCK) signal is transmitted to the gate signal producer 17 equipped in the second gate driver 2B from the delay circuit 4B through the signal line 6B.

Then, the second or subsequent gate drivers 2B to 2N and the delay circuits 4B associated with the gate drivers 2B to 2N operate in the same way as the first gate driver 2A and the delay circuit 4B associated with the first gate driver 2A.

Specifically, the gate signal producer 17 equipped in the gate driver 2M (B<M<(N−1)) receives the start pulse (VSP) signal and the out-enable (VOE) signal from the gate signal producer 17 equipped in the gate driver 2(M−1) through the signal line 6A, and further receives the clock (VCK) signal from the delay circuit 4B associated with the gate driver 2(M−1).

Then, the gate signal producer 17 equipped in the gate driver 2M produces and outputs a gate signal VOUTM to the liquid crystal panel 110 in accordance with the received gate control signals.

Then, the gate signal producer 17 equipped in the gate driver 2M transmits the start pulse (VSP) signal and the out-enable (VOE) signal to the gate driver 2(M+1) through the signal line 6A, and further transmits the clock (VCK) signal to the delay circuit 4B disposed in the signal line 6B between the gate driver 2M and the gate driver 2(M+1), together with the above-mentioned timing signal.

On receipt of the clock (VCK) signal and the timing signal, the delay circuit 4B delays the clock (VCK) signal relative to the out-enable (VOE) signal.

Then, the delay circuit transmits the delayed clock (VCK) signal to the gate signal producer 17 equipped in the gate driver 2(M+1).

In accordance with the first variant of the second exemplary embodiment, though peak currents cannot be dispersed in the first gate driver 2A because a timing at which the clock (VCK) signal rises up is coincident with a timing at which the out-enable (VOE) signal rises up, the same advantages as those provided by the above-mentioned first variant of the first exemplary embodiment can be obtained in the second and subsequent gate drivers 2B to 2N.

Furthermore, in accordance with the first variant of the second exemplary embodiment, the delay time Δtc is made greater in a gate driver disposed more downstream among the gate drivers 2A to 2N.

Specifically, the clock (VCK) signal running through the second gate driver 2B has the delay time Δtc, the clock (VCK) signal running through the third gate driver 2C has the delay time 2Δtc, and the clock (VCK) signal running through the fourth gate driver 2D has the delay time 3Δtc, for instance.

### Second Variant of Second Exemplary Embodiment

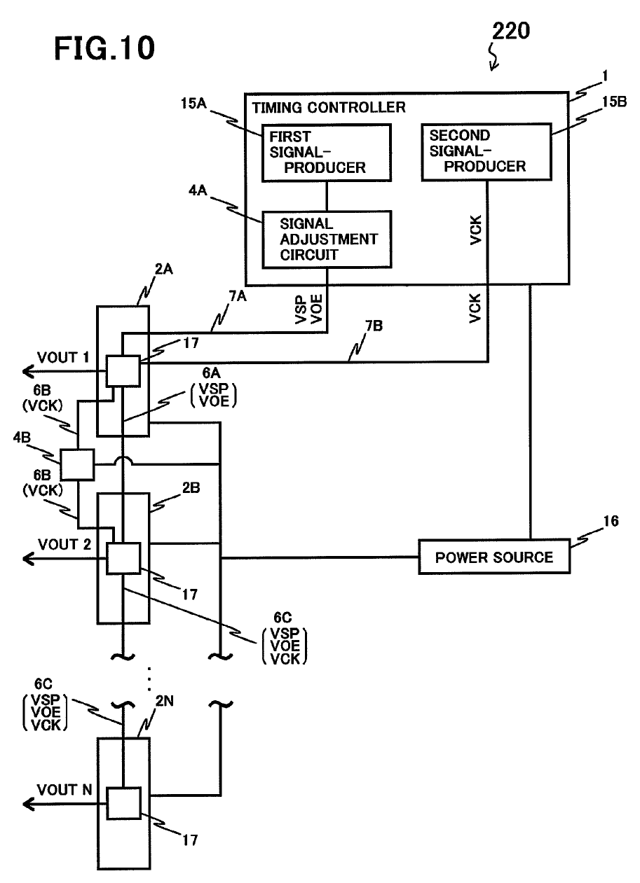

FIG. 10 is a block diagram of a liquid crystal driver circuit 220 in accordance with a second variant of the second exemplary embodiment of the present invention.

Whereas the delay circuit 4B is arranged in each of the signal lines 6B electrically connecting the gate drivers disposed adjacent to each other in the first variant of the second exemplary embodiment, as illustrated in FIG. 9, the delay circuit 4B is arranged only in the signal line 6B electrically connecting the first gate driver 2A and the second gate driver 2B with each other in the second variant of the second exemplary embodiment.

The second variant of the second exemplary embodiment is structurally different from the first variant of the second exemplary embodiment in the followings.

Firstly, as mentioned above, the delay circuit 4B is arranged only in the signal line 6B electrically connecting the first gate driver 2A and the second gate driver 2B with each other.

Secondly, the gate signal producers 17 equipped in the gate drivers 2B to 2N are electrically connected to each other through a signal line 6C.

As mentioned below, the start pulse (VSP) signal, the out-enable (VOE) signal, and the clock (VCK) signal passes through the signal lines 6C among the gate drivers 2B to 2N.

Thus, parts or elements that correspond to those of the first variant of the second exemplary embodiment have been provided with the same reference numerals, and operate in the same manner as corresponding parts or elements in the first embodiment, unless explicitly explained hereinbelow.

The timing controller 1, the first gate driver 2A, and the delay circuit 4B associated with the first gate driver 4A, that is, the delay circuit 4B disposed in the signal line 6B between the first gate driver 2A and the second gate driver 2B operate in the same way as those in the first variant of the second exemplary embodiment.

The second and subsequent gate drivers 2B to 2N operate in a different way from those in the first variant of the second exemplary embodiment.

For instance, the gate signal producer 17 equipped in the second gate driver 2B receives the start pulse (VSP) signal and the out-enable (VOE) signal from the gate signal producer 17 equipped in the first gate driver 2A through the signal line 6A, and further receives the delayed clock (VCK) signal from the delay circuit 4B.

Then, the gate signal producer 17 transmits the gate signal VOUT2 to the liquid crystal panel 110 (see FIG. 4) in accordance with the received gate control signals, that is, the start pulse (VSP) signal, the out-enable (VOE) signal, and the clock (VCK) signal.

After outputting the gate signal VOUT2, the gate signal producer 17 transmits the gate control signals to the gate signal producer 17 equipped in the third gate driver 2C, through the signal line 6C.

On receipt of the gate control signals from the gate signal producer 17 equipped in the second gate driver 2B, the gate signal producer 17 equipped in the third gate driver 2C transmits the gate signal VOUT3 to the liquid crystal panel 110 (see FIG. 4) in accordance with the received gate control signals.

Then, the gate signal producer 17 equipped in the third gate driver 2C transmits the gate control signals to the gate signal producer 17 equipped in the fourth gate driver 2D, through the signal line 6C.

Thus, the gate drivers 2B to 2N operate in the same way.

In accordance with the second variant of the second exemplary embodiment, a timing at which the delayed clock (VCK) rises up is kept delayed by Δtc relative to a timing at which the out-enable (VOE) signal rises up. Accordingly, the second variant of the second exemplary embodiment provides the same advantages as those provided by the above-mentioned first variant of the second exemplary embodiment.

In the second variant of the second exemplary embodiment, the delay time Δtc is common in each of the gate drivers 2B to 2N.

### Third Variant of Second Exemplary Embodiment

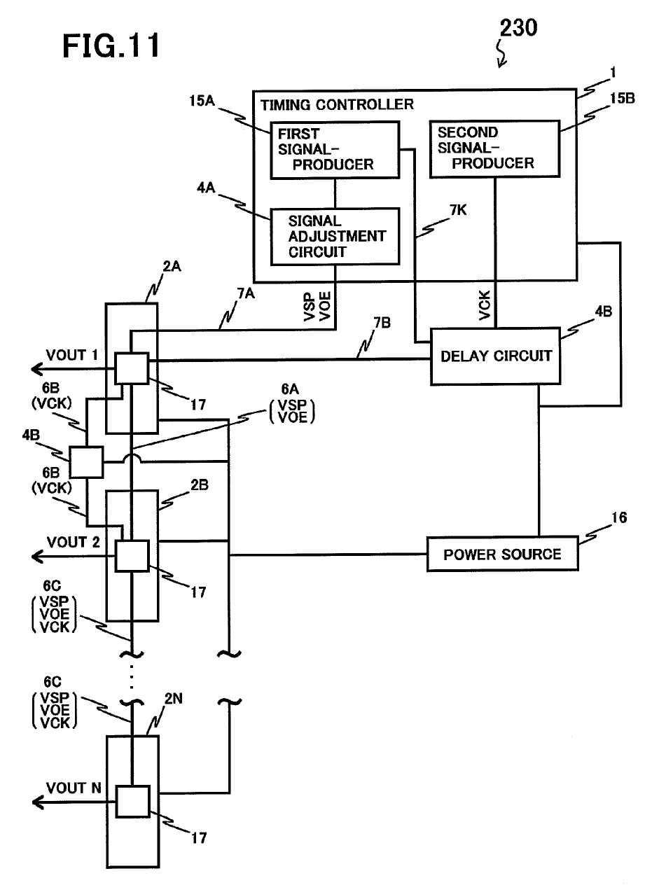

FIG. 11 is a block diagram of a liquid crystal driver circuit 230 in accordance with a third variant of the second exemplary embodiment of the present invention.

The delay circuit 4B is arranged in the signal line 7 outside the timing controller 1 in the second exemplary embodiment (FIG. 8), and the delay circuit 4B is arranged in the signal line 6B electrically connecting the first gate driver 2A and the second gate driver 2B with each other in the second variant of the second exemplary embodiment (FIG. 10). The second exemplary embodiment (FIG. 8) and the second variant of the second exemplary embodiment (FIG. 10) may be combined with each other. Specifically, the liquid crystal driver circuit 230 in accordance with the third variant of the second exemplary embodiment is designed to include both the delay circuit 4B in the signal line 7 outside the timing controller 1, and the delay circuit 4B in the signal line 6B electrically connecting the first gate driver 2A and the second gate driver 2B with each other

The third variant of the second exemplary embodiment is structurally different from the second variant of the second exemplary embodiment in additionally including the delay circuit 4B arranged in the signal line 7 outside the timing controller 1. Thus, parts or elements that correspond to those of the second variant of the second exemplary embodiment have been provided with the same reference numerals, and operate in the same manner as corresponding parts or elements in the first embodiment, unless explicitly explained hereinbelow.

In accordance with the third variant of the second exemplary embodiment, a timing at which the delayed clock (VCK) rises up is delayed by Δtc relative to a timing at which the out-enable (VOE) signal rises up in the first gate driver 2A, and a timing at which the delayed clock (VCK) rises up is kept delayed by 2Δtc relative to a timing at which the out-enable (VOE) signal rises up in the second to N-th gate drivers 2B to 2N. Accordingly, the third variant of the second exemplary embodiment provides the same advantages as those provided by the second exemplary embodiment.

In the above-mentioned second exemplary embodiment and the variants thereof, the timing controller 1 varies a timing at which a signal level of the start pulse (VSP) signal falls down, relative to a timing at which the out-enable (VOE) signal falls down. As an alternative, the timing controller 1 may vary a timing at which the out-enable (VOE) signal falls down, relative to a timing at which a signal level of the start pulse (VSP) signal falls down. In brief, the timing controller 1 may vary a timing at which one of the control signals falls down, relative to a timing at which the rest of the control signals falls down.

In the above-mentioned second exemplary embodiment and the variants thereof, the delay circuit 4B delays a timing at which the clock (VCK) signal rises up, by Δtc relative to a timing at which the out-enable (VOE) signal rises up. In contrast, the delay circuit 4B may be designed to delay the out-enable (VOE) signal relative to the clock (VCK) signal.

As an alternative, the delay circuit 4B may be designed to delay any two or more control signals relative to the rest of the control signals.

The first exemplary embodiment and the second exemplary embodiment may be combined with each other. Specifically, the delay circuit 4B may be equipped in the timing controller 1, the first gate driver 2A or all of the gate drivers 2A to 2N, and further, in the signal line 7 (or 7B), or in the signal line 6B.

### Third Exemplary Embodiment

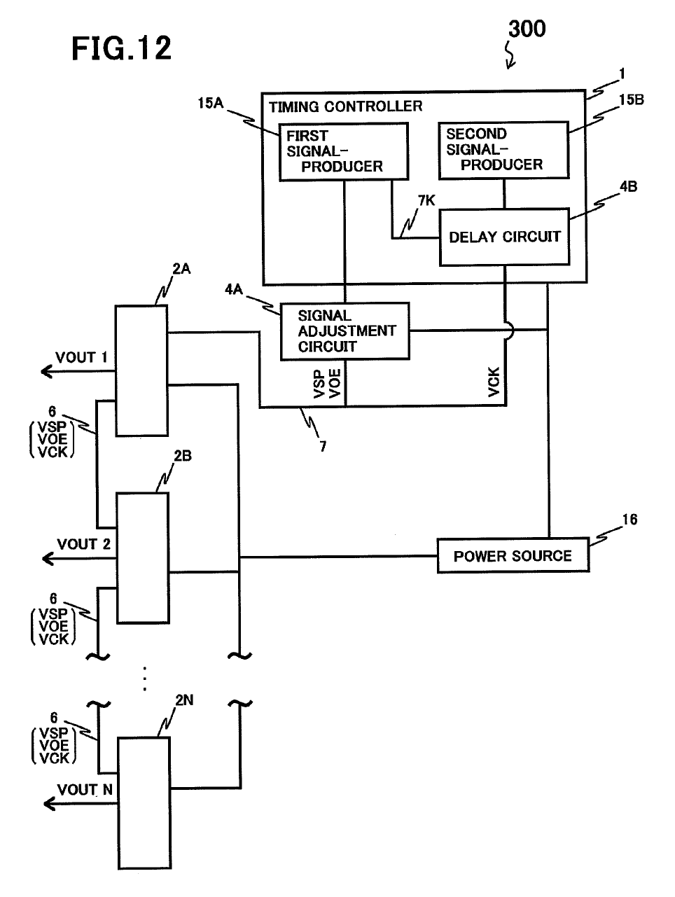

FIG. 12 is a block diagram of a liquid crystal driver circuit 300 in accordance with the third exemplary embodiment of the present invention.

As illustrated in FIG. 12, the liquid crystal driver circuit 300 in accordance with the third exemplary embodiment is comprised of a timing controller 1, a signal adjustment circuit 4A, and a plurality of gate drivers 2A to 2N.

Each of the gate drivers 2A to 2(N−1) is electrically connected with a gate driver disposed immediately downstream thereof through a signal line 6. That is, the gate drivers 2A to 2N are electrically connected in cascade with one another.

The timing controller 1 includes a first signal-producer 15A, a second signal-producer 15B, and a delay circuit 4B.

The first signal-producer 15A is electrically connected with the signal adjustment circuit 4A, and the signal adjustment circuit 4A is electrically connected with the first gate driver 2A through a signal line 7.

The second signal-producer 15B is electrically connected with the delay circuit 4B, and the delay circuit 4B is electrically connected with the first gate driver 2A through the signal line 7.

The first signal-producer 15A produces a start pulse (VSP) signal and an out-enable (VOE) signal both as gate control signals, and outputs those signals to the signal adjustment circuit 4A.

The second signal-producer 15B produces a clock (VCK) signal as a gate control signal, and outputs the clock (VCK) signal to the delay circuit 4B.

The first signal-producer 15A produces the start pulse (VSP) signal and the out-enable (VOE) signal. At this stage, a timing at which a signal level of the start pulse (VSP) signal falls down is coincident with a timing at which a signal level of the out-enable (VOE) signal falls down. On receipt of the start pulse (VSP) signal and the out-enable (VOE) signal from the first signal-producer 15A, the signal adjustment circuit 4A sets a timing at which a signal level of the start pulse (VSP) signal received from the first signal-producer 15A falls down, sooner by Δta or later by Δtb relative to a timing at which a signal level of the out-enable (VOE) signal received from the first signal-producer 15A falls down, thereby ensuring that those timings are not coincident with each other.

The second signal-producer 15B produces the clock (VCK) signal, and the delay circuit 4B delays a timing at which a signal level of the clock (VCK) signal received from the second signal-producer 15B rises up, by Δtc relative to a timing at which a signal level of the out-enable (VOE) signal rises up.

The first gate driver 2A transmits the gate control signals (that is, the start pulse (VSP) signal, the out-enable (VOE) signal, and the clock (VCK) signal) having been received from the timing controller 1, to the second gate driver 2B through the signal line 6. Then, the second gate driver 2B transmits the gate control signals having been received from the first gate driver 2A, to the third gate driver 2C through the signal line 6. In the same way, a gate driver 2M (A<M<N) transmits the gate control signals having been received from a gate driver 2(M−1), to a gate driver 2(M+1) through the signal line 6.

Each of the gate drivers 2A to 2N transmits a gate signal VOUT1 to VOUTN as a drive signal to the liquid crystal panel 110 (see FIG. 4) at a timing defined by the received gate control signals.

For instance, the signal adjustment circuit 4A is comprised of an integrated circuit (IC).

The timing controller 1, the delay circuit 4B, and the gate drivers 2A to 2N commonly receive electrical power from a power source 16 for operation thereof.

The liquid crystal driver circuit 300 in accordance with the third exemplary embodiment is structurally different from the liquid crystal driver circuit 100 in accordance with the third exemplary embodiment only in that the signal adjustment circuit 4A is not arranged in the timing controller 1, but is arranged in the signal line 7 outside the timing controller 1. Thus, the liquid crystal driver circuit 300 in accordance with the third exemplary embodiment operates in the same as the operation of the liquid crystal driver circuit 100 in accordance with the first exemplary embodiment.

Similarly to the liquid crystal display device 150 illustrated in FIG. 4, a liquid crystal display device may be comprised of the liquid crystal driver circuit 300, and a liquid crystal panel 110.

The liquid crystal panel 110 displays images in accordance with both the gate signals VOUT1 to VOUTN received from the gate drivers 2A to 2N, and source signals SOUT1 to SOUTN received from source drivers 10A to 10N (see FIG. 13).

The third exemplary embodiment provides the same advantages as those provided by the above-mentioned first exemplary embodiment.

The variants of the first exemplary embodiment, the second exemplary embodiment, and the variants of the second exemplary embodiment may be combined with the third exemplary embodiment.

As an alternative, the signal adjustment circuit 4A may be arranged in the first gate driver 2A, each of the first to N-th gate drivers 2A to 2N, and/or the signal line 6 electrically connecting the gate drivers disposed adjacent to each other.

In the above-mentioned third exemplary embodiment, the signal adjustment circuit 4A is designed to set a timing at which a signal level of the start pulse (VSP) signal falls down, sooner or later relative to a timing at which a signal level of the out-enable (VOE) signal falls down. As an alternative, the signal adjustment circuit 4A may be designed to set a timing at which a signal level of the start pulse (VSP) signal rises up, sooner or later relative to a timing at which a signal level of the out-enable (VOE) signal rises up, or may be designed to set both a timing at which a signal level of the start pulse (VSP) signal falls down and a timing at which a signal level of the start pulse (VSP) signal rises up, sooner or later relative to a timing at which a signal level of the out-enable (VOE) signal falls down and a timing at which a signal level of the out-enable (VOE) signal rises up, respectively.

### Fourth Exemplary Embodiment

FIG. 13 is a block diagram of a liquid crystal driver circuit 400 in accordance with the fourth exemplary embodiment of the present invention.

The liquid crystal driver circuit 400 in accordance with the fourth exemplary embodiment is structurally different from the liquid crystal driver circuit 100 in accordance with the first exemplary embodiment in the followings.

Firstly, the liquid crystal driver circuit 400 additionally includes first to L-th source drivers 10A to 10L each emitting a source signal SOUT1 to SOUTL to the liquid crystal panel 110.

Secondly, the timing controller 1 in the fourth exemplary embodiment additionally includes a third signal-producer 15C, and a second delay circuit 4C.

The liquid crystal driver circuit 400 in accordance with the fourth exemplary embodiment is structurally identical with the liquid crystal driver circuit 100 the first exemplary embodiment except the above-mentioned differences. Thus, parts or elements that correspond to those of the first exemplary embodiment have been provided with the same reference numerals, and operate in the same manner as corresponding parts or elements in the first embodiment, unless explicitly explained hereinbelow.

The third signal-producer 15C is designed to produce, for instance, a polarity inversion (PC) signal, and a data-latch pulse (DLP) signal as source control signals. The produced polarity inversion (PC) signal and data-latch pulse (DLP) signal are transmitted to the second delay circuit 4C from the third signal-producer 15C.

The second delay circuit 4C receives the polarity inversion (PC) signal and the data-latch pulse (DLP) signal from the third signal-producer 15C.

The second delay circuit 4C is electrically connected to the second signal-producer 4B through a signal line 7S. The second delay circuit 4C receives a timing signal indicative of a timing at which a signal level of a clock (VCK) signal varies, for instance, a timing at which a signal level of a clock (VCK) signal rises up, through the signal line 7S.

On receipt of the polarity inversion (PC) signal and the timing signal, the second delay circuit 4C delays a timing at which a signal level of the polarity inversion (PC) signal varies, by a predetermined time Δt, relative to a timing at which a signal level of the clock (VCK) signal varies.

The second delay circuit 4C is comprised of a delay line, for instance.

Each of the source drivers 2A to 2L is electrically connected to the second delay circuit 4C through a signal line 7L.

Each of the source drivers 2A to 2L receives electrical power from the power source 16 for operation thereof.

With respect to the transmission of the gate signals VOUT1 to VOUTN, the liquid crystal driver circuit 400 in accordance with the fourth exemplary embodiment operates in the same way as that of the liquid crystal driver circuit 100 the first exemplary embodiment. Accordingly, the operation for outputting the source signals SOUT1 to SOUTL in the liquid crystal driver circuit 400 in accordance with the fourth exemplary embodiment is explained hereinbelow.

The third signal-producer 15C produces the polarity inversion (PC) signal and the data-latch pulse (DLP) signal, and transmits those signals to the second delay circuit 4C.

On receipt of the polarity inversion (PC) signal and the data-latch pulse (DLP) signal from the third signal-producer 15C, and further on receipt of the timing signal from the second signal-producer 15B through the signal line 7S, the second delay circuit 4C delays a timing at which a signal level of the polarity inversion (PC) signal varies, by a predetermined time Δt, relative to a timing at which a signal level of the clock (VCK) signal varies.

Then, the second delay circuit 4C outputs the delayed polarity inversion (PC) signal and the data-latch pulse (DLP) signal to each of the first to L-th source drivers 2A to 2L through the signal line 7L.

On receipt of the delayed polarity inversion (PC) signal and the data-latch pulse (DLP) signal, each of the source drivers 2A to 2L outputs the source signals SOUT1 to SOUTL, respectively, to the liquid crystal panel 110 (see FIG. 4).

The fourth exemplary embodiment provides the same advantages as those provided by the first exemplary embodiment, and additionally provides the advantage that it is possible to reduce power consumption and ripple of logic power source by delaying a timing at which a signal level of the polarity inversion (PC) signal varies, by a predetermined time Δt, relative to a timing at which a signal level of the clock (VCK) signal varies.

In the above-mentioned fourth exemplary embodiment, the second delay circuit 4C is designed to delay a timing at which a signal level of the polarity inversion (PC) signal varies, by a predetermined time Δt, relative to a timing at which a signal level of the clock (VCK) signal varies. As an alternative, the second delay circuit 4C may be designed to delay a timing at which a signal level of the data-latch pulse (DLP) signal varies, by a predetermined time Δt, relative to a timing at which a signal level of the clock (VCK) signal varies, or to delay both a timing at which a signal level of the polarity inversion (PC) signal varies and a timing at which a signal level of the data-latch pulse (DLP) signal varies, by a predetermined time Δt, relative to a timing at which a signal level of the clock (VCK) signal varies.

The second delay circuit 4C may be comprised of an integrated circuit in place of a delay line, in which case, it is possible to set a timing at which a signal level of the polarity inversion (PC) signal and/or the data-latch pulse (DLP) signal falls down, sooner or later relative to a timing at which a signal level of the clock (VCK) signal falls down, or may be designed to set both a timing at which a signal level of the polarity inversion (PC) signal and/or the data-latch pulse (DLP) signal falls down and a timing at which a signal level of the polarity inversion (PC) signal and/or the data-latch pulse (DLP) signal rises up, sooner or later relative to a timing at which a signal level of the out-enable (VOE) signal falls down and a timing at which a signal level of the out-enable (VOE) signal rises up, respectively.

The liquid crystal driver circuit 400 in accordance with the fourth exemplary embodiment is designed to include the liquid crystal driver circuit 100 in accordance with the first exemplary embodiment. As an alternative, the liquid crystal driver circuit 400 may be designed to include the liquid crystal driver circuit in accordance with the variants of the first exemplary embodiment, the second exemplary embodiment, or the variants of the second exemplary embodiment in place of the liquid crystal driver circuit 100 in accordance with the first exemplary embodiment.

The liquid crystal driver circuit 400 in accordance with the fourth exemplary embodiment is designed to include a plurality of the signal lines 7L through which the polarity inversion (PC) signal and the data-latch pulse (DLP) signal are transmitted to the first to L-th source drivers 2A to 2L. As an alternative, the liquid crystal driver circuit 400 may be designed to include a single signal line 7L in place of a plurality of the signal lines 7L such that the signal line electrically connects the timing controller 1 and each of the source drivers 2A to 2L with each other, in which case, the polarity inversion (PC) signal and the data-latch pulse (DLP) signal are transmitted through the single signal line.

The above-mentioned matter is applied to the later-mentioned exemplary embodiments and variants thereof which include a plurality of the signal lines 7L for transmitting the polarity inversion (PC) signal and the data-latch pulse (DLP) signal to the source drivers 2A to 2L.

### First Variant of Fourth Exemplary Embodiment

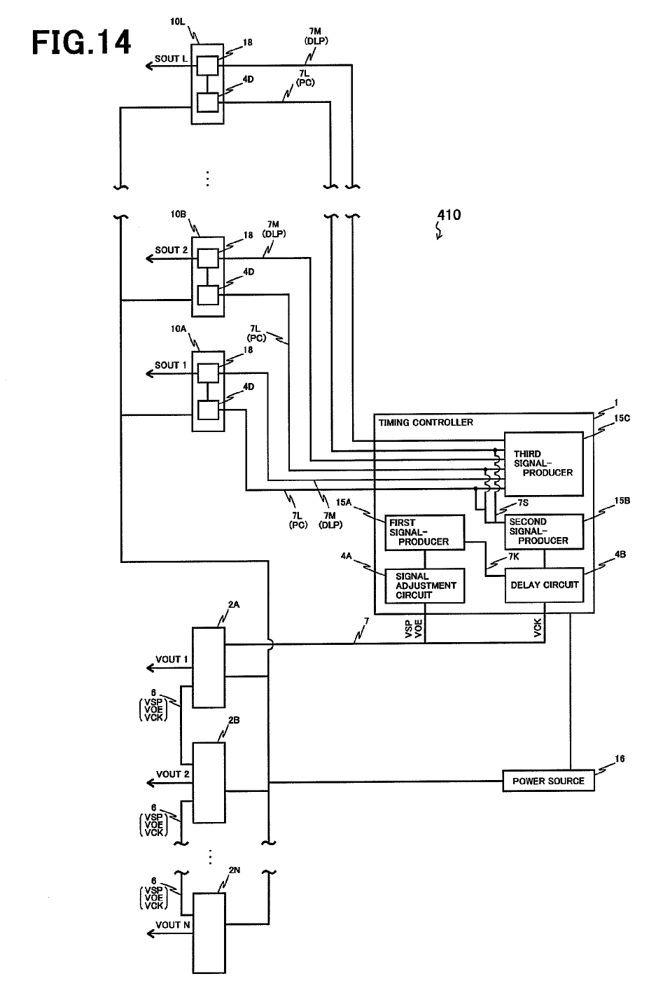

FIG. 14 is a block diagram of a liquid crystal driver circuit 410 in accordance with a first variant of the fourth exemplary embodiment of the present invention.

The liquid crystal driver circuit 410 in accordance with the first variant of the fourth exemplary embodiment is structurally different from the liquid crystal driver circuit 400 the fourth exemplary embodiment in the followings.

Firstly, the timing controller 1 in the first variant of the fourth exemplary embodiment is designed not to include the second delay circuit 4C.

Secondly, each of the first to L-th source drivers 10A to 10L is designed to include a source signal producer 18 which produces and outputs a source signal SOUT1 to SOUTL to the liquid crystal panel 110.

Thirdly, each of the first to L-th source drivers 10A to 10L is designed to include a third delay circuit 4D.

The liquid crystal driver circuit 410 in accordance with the first variant of the fourth exemplary embodiment is structurally identical with the liquid crystal driver circuit 400 in accordance with the first exemplary embodiment except the above-mentioned differences. Thus, parts or elements that correspond to those of the fourth exemplary embodiment have been provided with the same reference numerals, and operate in the same manner as corresponding parts or elements in the first embodiment, unless explicitly explained hereinbelow.

Each of the third delay circuits 4D equipped in the first to L-th source drivers 10A to 10L is electrically connected to the third signal producer 15C through a signal line 7L, and is further electrically connected to each of the source signal producers 18 equipped in the first to L-th source drivers 10A to 10L, respectively. That is, each of the third delay circuits 4D equipped in the first to L-th source drivers 10A to 10L is disposed downstream of the third signal producer 15C in the signal line 7L, and is disposed upstream of each of the source signal producers 18. The polarity inversion (PC) signal is transmitted to the third delay circuits 4D from the third signal producer 15C through the signal lines 7L.

Each of the source signal producers 18 equipped in the source drivers 10A to 10L is electrically connected to the third signal producer 15C through a signal line 7M. The data-latch pulse (DLP) signal is transmitted to the source signal producers 18 from the third signal producer 15C through the signal lines 7M.

The operation of the liquid crystal driver circuit 410 in accordance with the first variant of the fourth exemplary embodiment is different from the operation of the liquid crystal driver circuit 400 in accordance with the fourth exemplary embodiment only in that whereas the polarity inversion (PC) signal is delayed by the second delay circuit 4C in the fourth exemplary embodiment, the polarity inversion (PC) signal is delayed by each of the third delay circuits 4D in the first variant of the fourth exemplary embodiment.

The third signal producer 15C equipped in the timing controller 1 transmits the polarity inversion (PC) signal and the data-latch pulse (DLP) signal to each of the third delay circuits 4D equipped in the first to L-th source drivers 10A to 10L, through the signal lines 7L and 7M, respectively.

On receipt of the polarity inversion (PC) signal, each of the third delay circuits 4D equipped in the first to L-th source drivers 10A to 10L delays the polarity inversion (PC) signal relative to the clock (VCK) signal. Specifically, each of the third delay circuits 4D delays a timing at which a signal level of the polarity inversion (PC) signal varies, by a predetermined time Δt, relative to a timing at which a signal level of the clock (VCK) signal varies.

Then, each of the third delay circuits 4D outputs the delayed polarity inversion (PC) signal to the associated source signal producer 18.

On receipt of the polarity inversion (PC) signal from the associated third delay circuit 4D, the source signal producers 18 equipped in the first to L-th source drivers 10A to 10L outputs the source signals SOUT1 to SOUTL, respectively, to the liquid crystal panel 110 in accordance with both the polarity inversion (PC) signal received from the associated third delay circuit 4D and the data-latch pulse (DLP) signal received from the third signal producer 15C.

The liquid crystal driver circuit 410 in accordance with the first variant of the fourth exemplary embodiment provides the same advantages as those provided by the liquid crystal driver circuit 400 in accordance with the fourth exemplary embodiment.

The liquid crystal driver circuit 410 in accordance with the first variant of the fourth exemplary embodiment is designed to include the signal lines 7L through which the polarity inversion (PC) signal is transmitted to the third delay circuits 4D and the signal line 7M through which the data-latch pulse (DLP) signal is transmitted to the source signal producers 18. As an alternative, the liquid crystal driver circuit 410 may be designed to include a single signal line in place of the signal lines 7L and 7M such that the signal line electrically connects the third signal producer 15C and the first source driver 10A with each other, and further electrically connects the source drivers disposed adjacent to each other, in which case, the polarity inversion (PC) signal and the data-latch pulse (DLP) signal are transmitted through the single signal line, but only the polarity inversion (PC) signal is delayed by the third delay circuits 4D, and the data-latch pulse (DLP) signal is not delayed by the third delay circuits 4D.

The above-mentioned matter is applied to the later-mentioned variants which include a plurality of the signal lines 7L and 7M for transmitting the polarity inversion (PC) signal and the data-latch pulse (DLP) signal to the source drivers 2A to 2L.

### Second Variant of Fourth Exemplary Embodiment

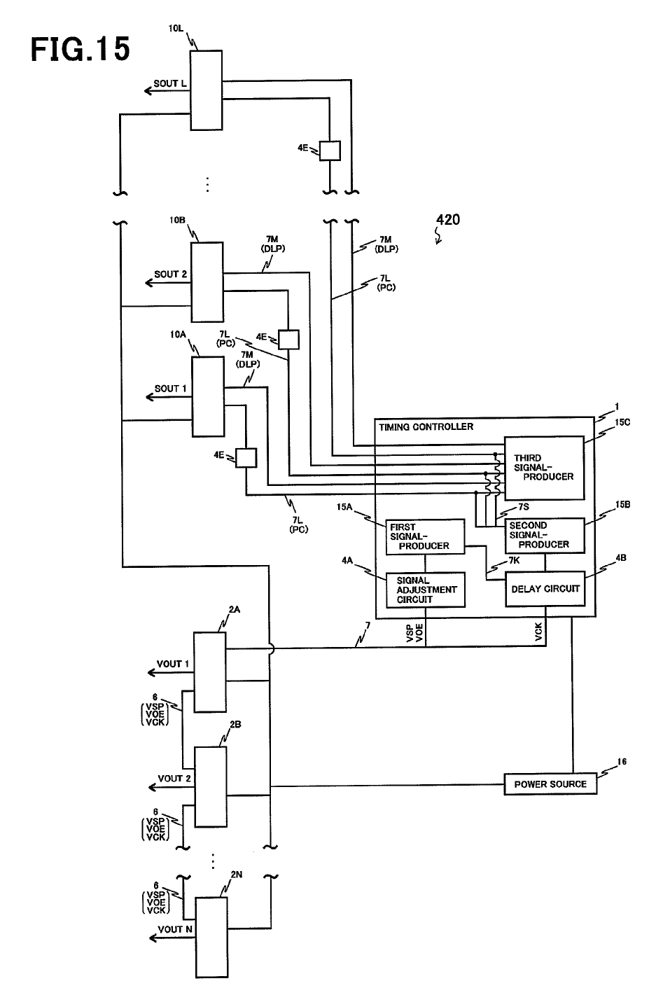

FIG. 15 is a block diagram of a liquid crystal driver circuit 420 in accordance with a second variant of the fourth exemplary embodiment of the present invention.

The liquid crystal driver circuit 420 in accordance with the second variant of the fourth exemplary embodiment is structurally different from the liquid crystal driver circuit 400 the fourth exemplary embodiment in the followings.

Firstly, the timing controller 1 in the second variant of the fourth exemplary embodiment is designed not to include the second delay circuit 4C.

Secondly, a fourth delay circuit 4E is arranged in each of signal lines 7L electrically connecting the third signal producer 15C to the first to L-th source drivers 10A to 10L, respectively.

The liquid crystal driver circuit 420 in accordance with the second variant of the fourth exemplary embodiment is structurally identical with the liquid crystal driver circuit 400 in accordance with the first exemplary embodiment except the above-mentioned differences. Thus, parts or elements that correspond to those of the fourth exemplary embodiment have been provided with the same reference numerals, and operate in the same manner as corresponding parts or elements in the first embodiment, unless explicitly explained hereinbelow.

The operation of the liquid crystal driver circuit 420 in accordance with the second variant of the fourth exemplary embodiment is different from the operation of the liquid crystal driver circuit 400 in accordance with the fourth exemplary embodiment only in that whereas the polarity inversion (PC) signal is delayed by the second delay circuit 4C in the fourth exemplary embodiment, the polarity inversion (PC) signal is delayed by each of the fourth delay circuits 4E in the second variant of the fourth exemplary embodiment.

Thus, the liquid crystal driver circuit 420 in accordance with second variant of the fourth exemplary embodiment provides the same advantages as those provided by the liquid crystal driver circuit 400 in accordance with the fourth exemplary embodiment.

### Third Variant of Fourth Exemplary Embodiment

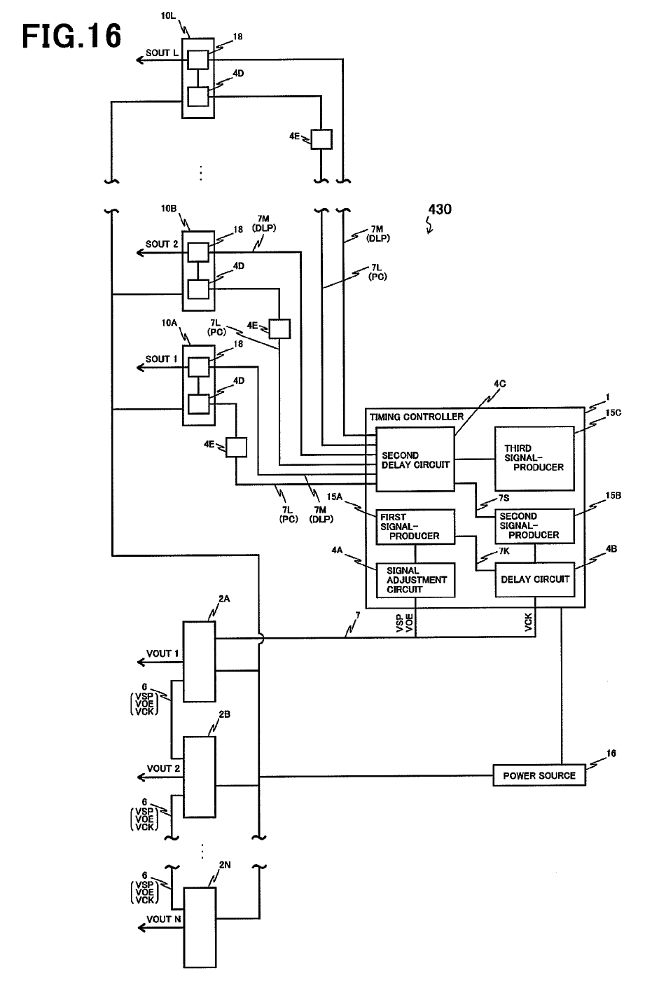

FIG. 16 is a block diagram of a liquid crystal driver circuit 430 in accordance with a third variant of the fourth exemplary embodiment of the present invention.

The liquid crystal driver circuit 430 in accordance with the third variant of the fourth exemplary embodiment is structurally different from the liquid crystal driver circuit 400 the fourth exemplary embodiment in the followings.

Firstly, each of the first to L-th source drivers 10A to 10L is designed to include a source signal producer 18 which produces and outputs a source signal SOUT1 to SOUTL to the liquid crystal panel 110.

Secondly, each of the first to L-th source drivers 10A to 10L is designed to include a third delay circuit 4D.

Thirdly, a fourth delay circuit 4E is arranged in each of signal lines 7L electrically connecting the third signal producer 15C to the first to L-th source drivers 10A to 10L, respectively.

The liquid crystal driver circuit 430 in accordance with the third variant of the fourth exemplary embodiment is structurally identical with the liquid crystal driver circuit 400 in accordance with the first exemplary embodiment except the above-mentioned differences. Thus, parts or elements that correspond to those of the fourth exemplary embodiment have been provided with the same reference numerals, and operate in the same manner as corresponding parts or elements in the first embodiment, unless explicitly explained hereinbelow.

In brief, the liquid crystal driver circuit 430 in accordance with the third variant of the fourth exemplary embodiment has the structure corresponding to a combination of the structures of the liquid crystal driver circuit 400 in accordance with the fourth exemplary embodiment, the liquid crystal driver circuit 410 in accordance with the first variant of the fourth exemplary embodiment, and the liquid crystal driver circuit 420 in accordance with the second variant of the fourth exemplary embodiment.

Thus, the operation of the liquid crystal driver circuit 430 in accordance with the third variant of the fourth exemplary embodiment is different from the operation of the liquid crystal driver circuit 400 in accordance with the fourth exemplary embodiment only in that whereas the polarity inversion (PC) signal is delayed by the second delay circuit 4C in the fourth exemplary embodiment, the polarity inversion (PC) signal is delayed by the second delay circuit 4C, the fourth delay circuits 4E, and the third delay circuit 4D in the third variant of the fourth exemplary embodiment.

Thus, the liquid crystal driver circuit 430 in accordance with third variant of the fourth exemplary embodiment provides the same advantages as those provided by the liquid crystal driver circuit 400 in accordance with the fourth exemplary embodiment.

In the liquid crystal driver circuit 430 in accordance with third variant of the fourth exemplary embodiment, the polarity inversion (PC) signal is delayed by the same delay time in each of the first to L-th source drivers 10A to 10L. Specifically, assuming that the polarity inversion (PC) signal is delayed by Δt1 by the second delay circuit 4C, by Δt2 by the fourth delay circuit 4E, and by Δt3 by the third delay circuit 4D, the polarity inversion (PC) signal is delayed by (Δt1+Δt2+Δt3) in each of the first to L-th source drivers 10A to 10L.

As is obvious to those skilled in the art, any one or more of the fourth exemplary embodiment and the first to third variants thereof may be combined with each other.

For instance, by combining the fourth exemplary embodiment and the first variant thereof with each other, the resultant liquid crystal driver circuit would include both the second delay circuit 4C illustrated in FIG. 13 and the third delay circuits 4D illustrated in FIG. 14. As an alternative, by combining the fourth exemplary embodiment and the second variant thereof with each other, the resultant liquid crystal driver circuit would include both the second delay circuit 4C illustrated in FIG. 13 and the fourth delay circuits 4E illustrated in FIG. 15.

The liquid crystal driver circuits in accordance with the above-mentioned first to fourth exemplary embodiments and the variants thereof are preferably applicable to an active matrix type liquid crystal display device, in particular to a TFT (thin film transistor) liquid crystal display device.

Apart from the above-mentioned exemplary embodiments, the present invention has preferred exemplary embodiments as follows.

In a preferred exemplary embodiment of the liquid crystal driver circuit, the timing controller delays a timing at which a signal level of at least one of the control signals varies, relative to a timing at which a signal level of the rest of the control signals varies.

In a preferred exemplary embodiment of the liquid crystal driver circuit, the timing controller sets a timing at which a signal level of at least one of the control signals varies, sooner or later than a timing at which the rest of the control signals varies.

In a preferred exemplary embodiment of the liquid crystal driver circuit, the liquid crystal driver circuit further includes a delay circuit which delays a timing at which a signal level of at least one of the control signals varies, relative to a timing at which a signal level of the rest of the control signals varies.

In a preferred exemplary embodiment of the liquid crystal driver circuit, the liquid crystal driver circuit further includes a signal adjustment circuit which sets a timing at which a signal level of at least one of the control signals varies, sooner or later than a timing at which the rest of the control signals varies.

In a preferred exemplary embodiment of the liquid crystal driver circuit, the control signals include a clock signal and an out-enable signal, the timing controller delaying a timing at which a signal level of the clock signal varies, relative to a timing at which a signal level of the out-enable signal varies.

In a preferred exemplary embodiment of the liquid crystal driver circuit, the control signals include a clock signal and an out-enable signal, the delay circuit delaying a timing at which a signal level of the clock signal varies, relative to a timing at which a signal level of the out-enable signal varies.

In a preferred exemplary embodiment of the liquid crystal driver circuit, the liquid crystal driver circuit further includes at least two source drivers receiving at least two control signals from the timing controller, and a second delay circuit for delaying a timing at which a signal level of at least one of the at least two control signals varies relative to a timing at which a signal level of the rest of the at least two control signals varies.

In a preferred exemplary embodiment of the liquid crystal driver circuit, the delay circuit is comprised of one of a delay line and an integrated circuit.

In a preferred exemplary embodiment of the liquid crystal driver circuit, the delay circuit is equipped in each of the gate drivers.

In a preferred exemplary embodiment of the liquid crystal driver circuit, the gate drivers are electrically connected in cascade with one another, and the delay circuit is equipped only in a gate driver disposed most upstream among the gate drivers.

In a preferred exemplary embodiment of the liquid crystal driver circuit, the delay circuit is equipped in both the timing controller and each of the gate drivers.

In a preferred exemplary embodiment of the liquid crystal driver circuit, the gate drivers are electrically connected in cascade with one another, and the delay circuit is disposed between the timing controller and a gate driver disposed most upstream among the gate drivers.

In a preferred exemplary embodiment of the liquid crystal driver circuit, the gate drivers are electrically connected in cascade with one another, and the delay circuit is disposed between gate drivers disposed adjacent to each other among the gate drivers.

In a preferred exemplary embodiment of the liquid crystal driver circuit, the gate drivers are electrically connected in cascade with one another, and the delay circuit is disposed between a first gate driver disposed most upstream among the gate drivers and a second driver disposed adjacent to the first gate driver.

In a preferred exemplary embodiment of the method of driving a liquid crystal display device, the step (b) includes a step of setting a timing at which a signal level of at least one of the control signals varies, sooner or later than a timing at which the rest of the control signals varies.

In a preferred exemplary embodiment of the liquid crystal driver circuit, the second delay circuit is arranged in at least one of the timing controller, each of the source drivers, and each of signal lines electrically connecting the timing controller and the source drivers with each other.

In a preferred exemplary embodiment of the method of driving a liquid crystal display device, assuming that the liquid crystal driver circuit further includes at least two source drivers receiving at least two control signals from the timing controller, the method further including varying a timing at which a signal level of at least one of the at least two control signals, relative to a timing at which a signal level of the rest of the at least two control signals varies.

The exemplary advantages obtained by the above-mentioned exemplary embodiments and variants thereof are described hereinbelow.

In accordance with the above-mentioned embodiments, it is possible to reduce logic power-source ripple, because signal levels of all of the control signals are designed not to vary simultaneously.

Furthermore, since the control signals running in a liquid crystal panel do not vary simultaneously, it is possible to disperse peak currents into different timings.

While the present invention has been described in connection with certain exemplary embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

This application is based upon and claims the benefit of priority from Japanese Patent Application No. 2007-087877 filed on Mar. 29, 2007, the entire disclosure of which, including specification, claims, drawings and summary, is incorporated herein by reference in its entirety.

What is claimed is:

1. A liquid crystal driver circuit comprising:
a timing controller emitting at least two control signals therefrom; and
at least two gate drivers receiving said control signals from said timing controller,
wherein said control signals are controlled such that signal levels thereof are not simultaneously varied.

2. The liquid crystal driver circuit as set forth in claim 1, wherein said timing controller delays a timing at which a signal level of at least one of said control signals varies, relative to a timing at which a signal level of the rest of said control signals varies.

3. The liquid crystal driver circuit as set forth in claim 1, wherein said timing controller sets a timing at which a signal level of at least one of said control signals varies, sooner or later than a timing at which the rest of said control signals varies.

4. The liquid crystal driver circuit as set forth in claim 1, further comprising a delay circuit which delays a timing at which a signal level of at least one of said control signals varies, relative to a timing at which a signal level of the rest of said control signals varies.

5. The liquid crystal driver circuit as set forth in claim 1, further comprising a signal adjustment circuit which sets a timing at which a signal level of at least one of said control signals varies, sooner or later than a timing at which the rest of said control signals varies.

6. The liquid crystal driver circuit as set forth in claim 2, wherein said control signals include a clock signal and an out-enable signal, said timing controller delaying a timing at which a signal level of said clock signal varies, relative to a timing at which a signal level of said out-enable signal varies.

7. The liquid crystal driver circuit as set forth in claim 4, wherein said control signals include a clock signal and an out-enable signal, said delay circuit delaying a timing at which a signal level of said clock signal varies, relative to a timing at which a signal level of said out-enable signal varies.

8. The liquid crystal driver circuit as set forth in claim 4, wherein said delay circuit is comprised of one of a delay line and an integrated circuit.

9. The liquid crystal driver circuit as set forth in claim 4, wherein said delay circuit is equipped in each of said gate drivers.

10. The liquid crystal driver circuit as set forth in claim 4, wherein said gate drivers are electrically connected in cascade with one another, and said delay circuit is equipped only in a gate driver disposed most upstream among said gate drivers.

11. The liquid crystal driver circuit as set forth in claim 4, wherein said delay circuit is equipped in both said timing controller and each of said gate drivers.

12. The liquid crystal driver circuit as set forth in claim 4, wherein said gate drivers are electrically connected in cascade with one another, and said delay circuit is disposed between said timing controller and a gate driver disposed most upstream among said gate drivers.

13. The liquid crystal driver circuit as set forth in claim 4, wherein said gate drivers are electrically connected in cascade with one another, and said delay circuit is disposed between gate drivers disposed adjacent to each other among said gate drivers.

14. The liquid crystal driver circuit as set forth in claim 4, wherein said gate drivers are electrically connected in cascade with one another, and said delay circuit is disposed between a first gate driver disposed most upstream among said gate drivers and a second driver disposed adjacent to said first gate driver.

15. The liquid crystal driver circuit as set forth in claim 1, further comprising at least two source drivers receiving at least two control signals from said timing controller, and a second delay circuit for delaying a timing at which a signal level of at least one of said at least two control signals varies relative to a timing at which a signal level of the rest of said at least two control signals varies.

16. The liquid crystal driver circuit as set forth in claim 15, wherein said second delay circuit is arranged in at least one of said timing controller, each of said source drivers, and each of signal lines electrically connecting said timing controller and said source drivers with each other.

17. A liquid crystal display device comprising:
a liquid crystal driver circuit; and
a liquid crystal panel,
said liquid crystal driver circuit comprising:
a timing controller emitting at least two control signals therefrom; and
at least two gate drivers each receiving said control signals from said timing controller, and each outputting a gate control signal,
wherein said control signals are controlled such that signal levels thereof are not simultaneously varied, and
said liquid crystal display panel receives said gate control signal from said gate drivers for operation thereof.

18. A method of driving a liquid crystal display device comprising a liquid crystal driver circuit and a liquid crystal panel, said liquid crystal driver circuit including a timing controller emitting at least two control signals therefrom, and at least two gate drivers receiving said control signals and outputting a gate control signal to said liquid crystal display panel,
said method comprising:
(a) producing at least two control signals in said timing controller;
(b) varying a timing at which a signal level of at least one of said control signals varies, relative to a timing at which a signal level of the rest of control signals varies; and
(c) transmitting said control signals to said liquid crystal panel from said liquid crystal driver circuit.

19. The method as set forth in claim 18, wherein said step (b) includes a step of setting a timing at which a signal level of at least one of said control signals varies, sooner or later than a timing at which the rest of said control signals varies.

20. The method as set forth in claim 18, wherein said liquid crystal driver circuit further includes at least two source drivers receiving at least two control signals from said timing controller,
said method further comprising varying a timing at which a signal level of at least one of said at least two control signals, relative to a timing at which a signal level of the rest of said at least two control signals varies.
